(19) United States
(12) Patent Application Publication
(10) Pub. No.: US 2026/0078001 A1
(43) Pub. Date: Mar. 19, 2026

(54) SYSTEMS, METHODS, AND TECHNIQUES FOR PROCESSING HYDROGEN SULFIDE

(71) Applicant: OHIO STATE INNOVATION FOUNDATION, Columbus, OH (US)

(72) Inventors: Liang-Shih Fan, Columbus, OH (US); Sonu Kumar, Columbus, OH (US); Kalyani V. Jangam, Columbus, OH (US)

(21) Appl. No.: 19/109,968

(22) PCT Filed: Sep. 8, 2023
(86) PCT No.: PCT/US2023/073729

§ 371 Date: Mar. 7, 2025

Related U.S. Application Data
(60) Provisional application No. 63/405,232, filed on Sep. 9, 2022.

(51) Int. Cl. C01B 17/04; B01D 53/047; C01B 3/04; C01B 21/04

(52) U.S. Cl. CPC C01B 17/0447; B01D 53/047; C01B 3/04; C01B 21/0405

(57) ABSTRACT

Exemplary systems and methods may convert hydrogen sulfide to hydrogen gas (H₂) and sulfur gas (S) via a decomposition process. Exemplary systems, methods, and techniques disclosed herein may provide hydrogen gas (H₂), sulfur gas (S), and/or oxygen-source material. Exemplary systems and methods may comprise a cyclic process system.

### CROSS-REFERENCE TO RELATED APPLICATION(S)

This application claims priority to U.S. Provisional Patent Application No. 63/405,232, filed on Sep. 9, 2022, the entire contents of which are hereby incorporated by reference in its entirety.

### FIELD

The present disclosure is related to systems, methods, and techniques for converting hydrogen sulfide (H₂S) to hydrogen (H₂) and sulfur (S).

### INTRODUCTION

Hydrogen sulfide (H₂S) is a highly flammable and corrosive gas that can cause severe consequences when present above the permissible concentration limit in the atmosphere or industrial processes. It occurs naturally within crude fossil fuels such as oil and natural gas, volcanic emissions, and decayed organic matter. Various industrial activities, including but not limited to fossil fuel extraction and processing, mining, and wastewater treatment, also generate hydrogen sulfide as a part of their exhaust gas stream. When present in the process feed streams, hydrogen sulfide (H₂S) can cause catalyst poisoning and material corrosion. In addition to its flammable nature, its direct release into the atmosphere can be fatal and can also lead to acid rain on oxidation. Accordingly, there is a need to safely handle hydrogen sulfide (H₂S).

Existing solutions require multiple processes in combination to separate and treat H₂S from the sour or acid gas stream. Liquid solvent absorption utilizing amines or alcohol such as methyl diethanolamine, Selexol, and Rectisol is widely adopted for H₂S separation, producing a high concentration H₂S stream during the solvent regeneration step. This H₂S stream is then sent to the Claus process for H₂S decomposition into steam and elements sulfur. Because the Claus process cannot handle a high concentration of hydrocarbons, hydrogen gas (H₂), or oxidative gases, the solvent absorption process is required for H₂S separation and subsequent concentration. Additionally, the thermodynamic constraint for the need for low temperature and the kinetics of the catalytic step of the process cause the use of multiple catalyst beds, and the overall sulfur recovery is limited to about 97%. More importantly, the underlying oxidative chemistry of the process cannot recover hydrogen gas (H₂) along with sulfur due to the generation of steam.

Currently used processes for removing H₂S require the use of an air separation unit, resulting in processes that are cost intensive and demand high energy use. Furthermore, industrial sour or acid gas streams often contain reactive gases, including but not limited to, H₂O, COS, NH₃, CO₂, and hydrocarbons, along with H₂S in variable concentrations. These reactive gases can negatively impact the selectively of H₂S conversion to H₂, as well as solid recyclability due to the formation of unwanted phases. Therefore, there is a need for process operation and material design that can maintain high selectivity and yield production of H₂S conversion to H₂, and solid recyclability in the presence of such reactive gases, particularly oxidative gases.

### SUMMARY

In one aspect, a method for operating a reactor system is disclosed. An exemplary method may comprise providing hydrogen sulfide (H₂S) and nitrogen gas (N₂) to a sulfidation and regeneration system; providing nitrogen gas (N₂) and sulfur gas (S) from a first outlet of the sulfidation and regeneration system to an inlet of a sulfur condenser; providing hydrogen gas (H₂) and waste gas from a second outlet of the sulfidation and regeneration system to an inlet of a hydrogen separation unit; separating, in the hydrogen separation unit, a hydrogen gas (H₂) product from waste gas; providing a first output from the hydrogen separation unit to a first inlet of a nitrogen separation system, the first output comprising either the hydrogen gas (H₂) product or the waste gas; providing an oxygen-source input stream to a second inlet of the nitrogen separation system, the oxygen-source input stream comprising nitrogen (N₂) and oxygen (O₂); generating, in the nitrogen separation system, a plurality of oxidized oxygen carriers by contacting oxygen (O₂) with a plurality of reduced oxygen carriers; providing nitrogen (N₂) from a first outlet of the nitrogen separation system to the sulfidation and regeneration system; generating, in the nitrogen separation system, oxygen-comprising material and the plurality of reduced oxygen carriers by reacting the first output from the hydrogen separation unit with the plurality of oxidized oxygen carriers; and providing the oxygen-comprising material from a second outlet of the nitrogen separation system.

In another aspect, a reactor system is disclosed. An exemplary reactor system may comprise a sulfidation and regeneration system comprising: a first inlet in fluid communication with a hydrogen sulfide (H₂S) stream; a second inlet in fluid communication with a nitrogen gas (N₂) stream; a first outlet configured to provide a stream comprising nitrogen gas (N₂) and sulfur gas (S); and a second outlet in fluid communication with a hydrogen separation unit; the hydrogen separation unit comprising: an inlet in fluid communication with the second outlet of the sulfidation and regeneration system; a first outlet configured to provide a hydrogen gas product stream; and a second outlet configured to provide a waste gas stream; and a nitrogen separation system comprising: a first inlet in fluid communication with a slip stream from either the hydrogen gas product stream or the waste gas stream; a second inlet in fluid communication with an oxygen-source input stream, the oxygen-source input stream comprising nitrogen (N₂) and oxygen (O₂); a first outlet in fluid communication with the second inlet of the sulfidation and regeneration system; and a second outlet configured to provide oxygen-comprising material.

In another aspect, a reactor system is disclosed. An exemplary reactor system may comprise a sulfidation and regeneration system comprising: a first inlet in fluid communication with a hydrogen sulfide (H₂S) stream; a second inlet in fluid communication with a nitrogen gas (N₂) input stream; a first outlet configured to provide a nitrogen gas (N₂) and sulfur gas (S) stream; and a second outlet configured to provide a desulfurized hydrogen gas-containing stream; and a first heat exchanger comprising: a first inlet in fluid communication with the first outlet of the sulfidation and regeneration system; a second inlet in fluid communication with the nitrogen gas (N₂) input stream; a first outlet in fluid communication with a first inlet of a heating unit; and a second outlet configured to provide a cooled nitrogen gas (N₂) and sulfur gas (S) stream; a sulfur condenser comprising: an inlet in fluid communication with the cooled nitrogen gas (N₂) and sulfur gas (S) stream; a first outlet of the sulfur condenser configured to provide a sulfur gas (S) stream; and a second outlet of the sulfur condenser configured to provide a separated nitrogen gas (N₂) stream, the separated nitrogen gas (N₂) stream in fluid communication with an inlet of the nitrogen gas (N₂) input stream; and the heating unit comprising: the first inlet in fluid communication with the first outlet of the first heat exchanger; a second inlet in fluid communication with a natural gas stream; and an outlet in fluid communication with the second inlet of the sulfidation and regeneration system.

In another aspect, a method for operating a reactor system is disclosed. An exemplary method may comprise providing hydrogen sulfide (H₂S) gas to a first inlet of a sulfidation and regeneration system; providing nitrogen gas (N₂) to a second inlet of the sulfidation and regeneration system; generating, in the sulfidation and regeneration system, desulfurized hydrogen-containing gas and sulfur gas (S) by reacting the hydrogen sulfide (H₂S) gas with a plurality of metal sulfide particles; providing the desulfurized hydrogen-containing gas from a first outlet of the sulfidation and regeneration system; providing nitrogen gas (N₂) and the sulfur gas (S) from a second outlet of the sulfidation and regeneration system to a first inlet of a first heat exchanger; providing the nitrogen gas (N₂) and the sulfur gas (S) from a first outlet of the first heat exchanger to an inlet of a sulfur condenser; obtaining the sulfur gas (S) from a first outlet of the sulfur condenser; providing the nitrogen gas (N₂) from a second outlet of the sulfur condenser to an inlet of a supplementary nitrogen gas (N₂) stream; providing the supplementary nitrogen gas (N₂) stream to the second inlet of the first heat exchanger; and providing the supplementary nitrogen gas (N₂) stream from a second outlet of the first heat exchanger to an inlet of a heating unit; and providing the supplementary nitrogen gas (N₂) stream from an outlet of the heating unit to the second inlet of the sulfidation and regeneration system.

### BRIEF DESCRIPTION OF THE DRAWINGS

FIG. 1 schematically shows an exemplary reactor system including a sulfidation and regeneration system, a hydrogen separation unit, a nitrogen separation unit, a sulfur condenser, and a blower.

FIG. 2 schematically shows another exemplary reactor system including a sulfidation and regeneration system, a hydrogen separation unit, a first reactor, a second reactor, a sulfur condenser, and a blower.

FIG. 3 schematically shows another exemplary reactor system including a sulfidation and regeneration system, a hydrogen separation unit, a furnace, a first reactor, a second reactor, a sulfur condenser, and a blower.

FIG. 4 schematically shows an exemplary reactor system for hydrogen sulfide (H₂S) conversion to hydrogen gas (H₂) and sulfur (S).

FIG. 5 schematically shows another exemplary system for hydrogen sulfide (H₂S) conversion to hydrogen gas (H₂) and sulfur (S).

FIG. 6 is a flowchart of a method of operating an exemplary reactor system for H₂S conversion to H₂ and S.

FIG. 7 is a flowchart of a method of operating an exemplary reactor system for H₂S conversion to H₂ and S.

FIG. 8 shows computational thermodynamic studies data of conversion versus a molar ratio of steam (H₂O) and H₂S.

FIG. 9 shows computational thermodynamic studies data of conversion versus a molar ratio of carbonyl sulfide (COS) and H₂S.

FIG. 10 shows computational thermodynamic studies data of conversion versus molar ratio of ammonia (NH₃) and H₂S.

FIG. 11 shows experimental data of percent conversion for H₂S versus time.

### DETAILED DESCRIPTION

Systems, methods, and techniques disclosed herein may provide hydrogen gas (H₂), sulfur gas (S), and/or oxygen-source material. Exemplary systems and methods may comprise a cyclic process system.

Exemplary systems and methods may convert hydrogen sulfide to hydrogen gas (H₂) and sulfur gas (S) via a decomposition process, which occurs in two operations: sulfidation and regeneration. In a sulfidation operation, the H₂S from the feedstock reacts with metal-based composite solids, which capture the sulfur component of H₂S and release H₂ as a product. The solids obtained after the sulfidation process may then be regenerated in a regeneration process by heating up to a higher temperature in the presence of inert gases, including but not limited to nitrogen (N₂), argon (Ar), helium (He), or carbon dioxide (CO₂) to recover the captured sulfur.

Exemplary systems and methods may be capable of providing hydrogen gas (H₂) and sulfur (S) from hydrogen sulfide (H₂S)-containing feedstock at a lower expense and/or energy requirements than existing technology. An air separation unit (ASU) is one of the highest energy-consuming units in the overall process of hydrogen sulfide (H₂S) conversion to hydrogen (H₂) and sulfur (S) because of its high electricity consumption to produce a high purity nitrogen (N₂) from air for the regeneration step.

In some implementations described below, an inert gas, such as nitrogen (N₂), for the regeneration process can be satisfied by using a cyclic nitrogen (N₂) separator process utilizing oxygen carriers. Recovery gas and/or energy required for the cyclic process may be partially or completely satisfied using a hydrogen gas (H₂) product or waste gas produced during the sulfidation process. Exemplary systems and methods may be integrated with an existing industrial process which produces hydrogen sulfide (H₂S), including but not limited to, coal gasification, crude fossil fuel refining-processing, petrochemical processing, mineral processing, wastewater treatment, and biomass processing, for the hydrogen sulfide (H₂S) conversion to hydrogen gas (H₂) and sulfur (S).

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an,” and “the” include plural references unless the context clearly dictates otherwise. The present disclosure also contemplates other embodiments, “comprising,” “consisting of,” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about to about 4” also discloses the range “from 2 to 4.” The term “about” may refer to plus or minus 10% of the indicated number. For example, “about 10%” may indicate a rage of 9% to 11%, and “about 1” may mean from 0.9-1.1. Other meanings of “about” may be apparent from the context, such as rounding off, s, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For each recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.4, 6.5, 6.6, 6.7, 6.8, 6.9, and 7.0 are explicitly contemplated.

A “moving bed reactor” is defined as a reactor where catalytic material flows in a single direction, generally, from top to bottom. The fluid material can flow in the same direction as the catalytic material (co-current movement). The fluid material can flow in an opposite direction (countercurrent movement).

A “fluidized bed reactor” is defined as a reactor where fluid is passed through catalyst material at a sufficient speed to suspend the solid catalyst material. Typically, catalyst material may move in any direction, bounded by the walls of the reactor.

A “fixed bed reactor” is defined as a reactor where catalyst material is fixed in a packed bed. Fluid is passed through catalyst material but the fluid does not suspend the catalyst material, as in a fluidized bed reactor.

### II. Exemplary Materials

Exemplary systems and methods involve various materials, such hydrogen sulfide feedstocks, metal sulfide particles, oxygen carriers, oxygen-source gases, and oxidation-comprising materials. Examples of each are discussed below.

### A. Exemplary Hydrogen Sulfide Feedstock

Exemplary hydrogen sulfide feedstocks may be provided to exemplary reactors as individual streams, or as a mixed stream.

In various implementations exemplary hydrogen sulfide feedstocks may be provided from an industrial process that produces hydrogen sulfide (H₂S). Exemplary industrial processes may include coal gasification, crude fossil fuel refining-processing, petrochemical processing, mineral processing, wastewater treatment, biomass processing, or any combinations thereof.

In various implementations, exemplary hydrogen sulfide feedstock may include acid gas, sour gas, hydrogen sulfide (H₂S), carbon dioxide (CO₂), carbon monoxide (CO), carbonyl sulfide (COS), ammonia (NH₃), methane (CH₄), lower hydrocarbons (e.g., C2-C4), higher hydrocarbons (e.g., benzene, toluene, and xylene), and combinations thereof.

In various implementations, hydrogen sulfide feedstock may comprise up to 95 volume percent (vol. %) hydrogen sulfide (H₂S).

### B. Exemplary Metal Sulfide Particles

Various types of metal sulfide particles may be utilized in exemplary systems and methods. Generally, metal sulfide particles used in exemplary systems and methods are either in a reduced form or in an oxidized form. The reduced or oxidized terms refer to the change in oxidation state of the metal, lattice sulfur species, or both. Oxidized metal sulfide particles can react with an alkane, dehydrogenate the alkane, and form H₂S, which reduces the oxidized metal sulfide particle into a reduced metal sulfide or a metal/metal alloy. The reduced metal sulfide particle or metal/metal alloy can accept sulfur in the solid lattice from a sulfur source. Upon sulfur addition/oxidation, reduced metal sulfide particles can form oxidized metal sulfide particles.

Exemplary metal sulfide particles have an active metal capable of forming sulfides where active metal, sulfur, or both display one or more than one oxidation states. Generally, example metals (M) may be transition state, metalloid, or rare earth metals. In some instances, example metal sulfide particles may be bimetallic or trimetallic. Example metals (M) include, but are not limited to, Fe, Co, Ni, Cu, Cr, W, La, Ce, Ti, Zn, Cd, Ru, Rh, and Pb. The metals may include sulfide (S²⁻), persulfide (S₂²⁻), or another sulfur species.

There may be more than one active metal in a metal sulfide either in the form of a mixed metal sulfide or as a promotor or dopant. Dopants and promoters may be alkali metals, alkaline earth metals, transition state metals, metalloid metals, or rare earth metals. Supports may be inert oxides of alkali metals, sulfides of alkali metals, alkaline earth metals, transition state metals, metalloid metals, or rare earth metals. The amount of support, promotor, or dopant material may vary from 0.01 wt %, 10 wt %, 20 wt %, 30 wt % 40 wt %, 50 wt %, 60 wt %, 70 wt %, 80 wt %, 90 wt % or any value in between.

The metal sulfide may contain metal sulfides from group I or group II in the form of promotor, dopant, or to form mixed metal sulfides. Inert sulfides such as, but not limited to MoS₂, Ce₂S₃, MgS, Na₂S may be used as supports and dopants and promotors as well. Inert oxides that do not react with the metal sulfide may be used as promotor, dopant, or as a support. Examples of promotors, dopants, or supports may include, but not limited to, K₂O, MgO, SiO₂, ZrO₂ and Al₂O₃, as well as mixed metal oxides such as Mg Al₂O₄ and ZrSiO₄.

Oxides that do react with the sulfide to form metastable structures can also be considered as a metal sulfide. Dopants, promotors, and supports, in addition to other components, may provide high surface area, highly active sulfur vacancies.

Exemplary metal sulfide particles may be synthesized by any suitable method including, but not limited to, wet milling, extrusion, pelletizing, freeze granulation, co-precipitation, wet-impregnation, sol-gel, and mechanical compression. Certain techniques may be used to increase the strength and/or reactivity of exemplary metal sulfide particles, such as sintering synthesized particles or adding a binder or sacrificial agent with synthesis methods such as sol-gel combustion.

Exemplary metal sulfide particles may be provided as powders or pellets. Example powders may include metal sulfide particles having a size of about 100 μm. Example pellets may include metal sulfide particles having a size of about 2 mm.

Example metal sulfide particles may be bulk structures or mesoporous supported nanoparticles. Example bulk structures may have random orientations of large grains, cage-like structures for added physical strength, layered structure, or similar configurations. Example mesoporous supported metal sulfide particles may have a mesoporous support such as Santa Barbara Amorphous-15 silica (SBA-15), Santa Barbara Amorphous-16 silica (SBA-16), and other SBA variants, Mesoporous-Al₂O₃, Mesoporous CeO₂, etc., which have micro and meso pores, in which metal sulfide nanoparticles may be embedded.

Example metal sulfide particles may have various densities. For instance, example metal sulfide particles may have a density of from 1.5 g/cm³ to 6 g/cm³. In various implementations, example metal sulfide particles may have a density of from 1.5 g/cm³ to 3 g/cm³; 3 g/cm³ to 6 g/cm³; 2 g/cm³ to 4 g/cm³; 4 g/cm³ to 6 g/cm³; 1.5 g/cm³ to 2 g/cm³; 2 g/cm³ to 3 g/cm³; 3 g/cm³ to 4 g/cm³; 4 g/cm³ to 5 g/cm³; or 5 g/cm³ to 6 g/cm³.

### C. Exemplary Oxygen Carriers

Exemplary oxygen carriers are described below regarding example components, amounts, and physical properties. Exemplary oxygen carriers may change their oxidation state based on, at least, interaction with reducing and oxidizing gases. Exemplary oxygen carriers are used in nitrogen separation systems disclosed and contemplated herein.

Exemplary oxygen carriers may provide heat transfer throughout the nitrogen separation systems described herein. Exemplary oxygen carriers may provide for high heat-carrying capacity based on, at least, one or more active metal oxides (i.e., redox material) and one or more support materials (such as an inert material), thereby providing a heat balance across the exemplary systems.

### 1. Exemplary Chemical Constituents

Exemplary oxygen carriers may comprise one or more active metal oxides. In various implementations, the one or more active metal oxides comprises transition metal oxides such as, but not limited to, copper oxide, nickel oxide, manganese oxide, cobalt oxide, or any combination thereof.

Exemplary oxygen carriers may comprise of metal oxides and/or metal oxide derivatives that are capable of undergoing cyclic reduction and oxidation, thereby providing a change in the oxidation state of one or more constituents present in the exemplary oxygen carriers. In various implementations, carbon and hydrogen gas (H₂) may react with the oxygen carrier to produce CO, CO₂, H₂O, and/or remain unconverted.

In various implementations, the one or more active metal oxides may comprise 5 weight percent (wt %) to 95 wt % of the total weight of the exemplary oxygen carriers. In various implementations, the one or more active metal oxides may comprise, of the total weight of the exemplary oxygen carriers, 10 wt % to 95 wt %; 15 wt % to 95 wt %; 20 wt % to 95 wt %; 25 wt % to 95 wt %; 30 wt % to 95 wt %; 35 wt % to 95 wt %; 40 wt % to 95 wt %; 45 wt % to 95 wt %; 50 wt % to 95 wt %; 55 wt % to 95 wt %; 60 wt % to 95 wt %; 65 wt % to 95 wt %; 70 wt % to 95 wt %; 75 wt % to 95 wt %; 80 wt % to 95 wt %; 85 wt % to 95 wt %; 90 wt % to 95 wt %; 5 wt % to 90 wt %; 5 wt %; to 85 wt %; 10 wt % to 85 wt %; 15 wt % to 85 wt %; 20 wt % to 85 wt %; 20 wt % to 80 wt %; 25 wt % to 80 wt %; 25 wt % to 75 wt %; 30 wt % to 75 wt %; 30 wt % to 70 wt %; 35 wt % to 70 wt %; 35 wt % to 65 wt %; 40 wt % to 65 wt %; 40 wt % to 60 wt %; 45 wt % to 60 wt %; 45 wt % to 55 wt %; or about 50 wt %. In various implementations, the one or more active metal oxides may comprise no less than 5 wt %; no less than 15 wt %; no less than 25 wt %; no less than 35 wt %; no less than 45 wt %; no less than 55 wt %; no less than 65 wt %; no less than 75 wt %; or no less than 85 wt % of the total weight of the exemplary oxygen carriers. In various implementations, the one or more active metal oxides may comprise no greater than 95 wt %; no greater than 90 wt %; no greater than 80 wt %; no greater than 70 wt %; no greater than 60 wt %; no greater than 50 wt %; no greater than 40 wt %; no greater than 30 wt %; no greater than 20 wt %; or no greater than 10 wt % of the total weight of the exemplary oxygen carriers.

Exemplary oxygen carriers may comprise one or more support metal oxides. In various implementations, the one or more support metal oxides may comprise any known metal oxide in the art. In various implementations, the one or more support metal oxides may comprise SiO₂, SiC, Al₂O₃, MgO, CaO, alumina-silicates, ceramics, clay supports like kaolin and bentonite, alumina-zirconia-silica, or a combination comprising of two or more support materials.

In various implementations, the one or more support metal oxides may comprise 5 wt % to 95 wt % of the total weight of the exemplary oxygen carriers. In various implementations, the one or more support metal oxides may comprise, of the total weight of the exemplary oxygen carriers, 10 wt % to 95 wt %; 15 wt % to 95 wt %; 20 wt % to 95 wt %; 25 wt % to 95 wt %; 30 wt % to 95 wt %; 35 wt % to 95 wt %; 40 wt % to 95 wt %; 45 wt % to 95 wt %; 50 wt % to 95 wt %; 55 wt % to 95 wt %; 60 wt % to 95 wt %; 65 wt % to 95 wt %; 70 wt % to 95 wt %; 75 wt % to 95 wt %; 80 wt % to 95 wt %; 85 wt % to 95 wt %; 90 wt % to 95 wt %; 5 wt % to 90 wt %; 5 wt %; to 85 wt %; 10 wt % to 85 wt %; 15 wt % to 85 wt %; 20 wt % to 85 wt %; 20 wt % to 80 wt %; 25 wt % to 80 wt %; 25 wt % to 75 wt %; 30 wt % to 75 wt %; 30 wt % to 70 wt %; 35 wt % to 70 wt %; 35 wt % to 65 wt %; 40 wt % to 65 wt %; 40 wt % to 60 wt %; 45 wt % to 60 wt %; 45 wt % to 55 wt %; or about 50 wt %. In various implementations, the one or more support metal oxides may comprise no less than 5 wt %; no less than 15 wt %; no less than 25 wt %; no less than 35 wt %; no less than 45 wt %; no less than 55 wt %; no less than 65 wt %; no less than 75 wt %; or no less than 85 wt % of the total weight of the exemplary oxygen carriers. In various implementations, the one or more support metal oxides may comprise no greater than 95 wt %; no greater than 90 wt %; no greater than 80 wt %; no greater than 70 wt %; no greater than 60 wt %; no greater than 50 wt %; no greater than 40 wt %; no greater than 30 wt %; no greater than 20 wt %; or no greater than 10 wt % of the total weight of the exemplary oxygen carriers.

In various implementations, one or more dopants and promoters may provide active sites for adsorption of reactant gas molecules. In various implementations, one or more dopants and promoters may provide additional oxygen vacancies in the lattice of exemplary oxygen carriers, thereby improving the rates of ionic diffusion and lowering the activation energy barrier for product formation. In various implementations, the one or more promoters and dopants may comprise oxide, metallic, and other derivatives of elements including, but not limited to, Na, Li, K, Mg, Ca, Sr, Ba, Ce, La, Be, Ni, Co, Cu, Sc, Ti, V, Cr, Mn, Zn, Y, Zr, Nb, Mo, Tc, Ru, Rh, Pd, Ag, Cd, Lu, Hf, Ta, W, Re, Os, Ir, Pt, Au, or combinations thereof.

### 2. Physical Properties

Exemplary oxygen carriers have sufficient strength to withstand transport between reactors. Various physical properties of exemplary oxygen carriers, such as crushing mechanical strength, may be determined using methods disclosed in “Chemically and physically robust, commercially-viable iron-based composite oxygen carriers sustainable over 3000 redox cycles at high temperatures for chemical looping applications,” Chung et. al, Energy Environ. Sci., 2017, 10, 2318-2323, incorporated herein by reference in its entirety.

In various implementations, exemplary oxygen carriers may have a crushing mechanical strength between 1 MPa 200 MPa; 5 MPa to 200 MPa; 10 MPa to 200 MPa; 15 MPa to 200 MPa; 20 MPa to 200 MPa; 25 MPa to 200 MPa; 30 MPa to 200 MPa; 40 MPa to 200 MPa; 50 MPa to 200 MPa; 60 MPa to 200 MPa; 70 MPa to 200 MPa; 80 MPa; to 200 MPa; 90 MPa to 200 MPa; 100 MPa to 200 MPa; 120 MPa; to 200 MPa; 140 MPa to 200 MPa; or 150 MPa to 200 MPa. In various implementations, exemplary oxygen carriers have a crushing mechanical strength of no less than 1 MPa; no less than 5 MPa; no less than 15 MPa; no less than 25 MPa; no less than 35 MPa; no less than 45 MPa; no less than 75 MPa; no less than 95 MPa; no less than 125 MPa; no less than 155 MPa; no less than 175 MPa; or no less than 195 MPa. In various implementations, exemplary oxygen carriers have a crushing mechanical strength of no greater than 200 MPa; no greater than 180 MPa; no greater than 160 MPa; no greater than 140 MPa; no greater than 120 MPa; no greater than 100 MPa; no greater than 90 MPa; no greater than 80 MPa; no greater than 70 MPa; no greater than 60 MPa; no greater than 50 MPa; no greater than 40 MPa; no greater than 30 MPa; no greater than 20 MPa; no greater than 10 MPa; or no greater than 5 MPa.

In various implementations, exemplary oxygen carriers may have a particle size from 0.01 mm to 5 mm. As used herein, “particle size” may refer to a median particle size or a Dᵥ50 size. As used herein, the size may refer to a longest dimension of the particle. In various implementations, exemplary oxygen carriers may have a particle size from 0.01 mm to 5 mm; 0.02 mm to 5 mm; 0.03 mm to 5 mm; 0.04 mm to 5 mm; 0.05 mm to 5 mm; 0.06 mm to 5 mm; 0.07 mm to 5 mm; 0.08 mm to 5 mm; 0.09 mm to 5 mm; 0.1 mm to 5 mm; 0.5 mm to 5 mm; 0.8 mm to 5 mm; 1 mm to 5 mm; 1 mm to 4.5 mm; 1.2 mm to 4.5 mm; 1.5 mm to 4.5 mm; 1.5 mm to 4 mm; 1.8 mm to 4 mm; 2 mm to 4 mm; 2 mm to 3.5 mm; 2.5 mm to 3.5 mm; or about 3 mm. In various implementations, exemplary oxygen carriers may have a particle size of no less than 0.01 mm; no less than 0.02 mm; no less than 0.03 mm; no less than 0.04 mm; no less than 0.05 mm; no less than 0.06 mm; no less than 0.07 mm; no less than 0.08 mm; no less than 0.09 mm; no less than 0.1 mm; no less than 0.3 mm; no less than 0.5 mm; no less than 0.7 mm; no less than 0.9 mm; no less than 1.1 mm; no less than 1.3 mm; no less than 1.5 mm; no less than 1.7 mm; no less than 1.9 mm; no less than 2.1 mm; no less than 2.3 mm; no less than 2.5 mm; no less than 2.7 mm; no less than 2.9 mm; no less than 3.1 mm; no less than 3.3 mm; no less than 3.7 mm; no less than 3.9 mm; no less than 4.1 mm; no less than 4.3 mm; no less than 4.5 mm; no less than 4.7 mm; or no less than 4.9 mm. In various implementations, exemplary oxygen carries may have a particle size of no greater than 5 mm; no greater than 4.8 mm; no greater than 4.6 mm; no greater than 4.4 mm; no greater than 4.2 mm; no greater than 4 mm; no greater than 3.8 mm; no greater than 3.6 mm; no greater than 3.4 mm; no greater than 3.2 mm; no greater than 3 mm; no greater than 2.8 mm; no greater than 2.6 mm; no greater than 2.4 mm; no greater than 2.2 mm; no greater than 2 mm; no greater than 1.8 mm; no greater than 1.6 mm; no greater than 1.4 mm; no greater than 1.2 mm; no greater than 1 mm; no greater than 0.8 mm; no greater than 0.6 mm; no greater than 0.4 mm; no greater than 0.2 mm; no greater than 0.08 mm; no greater than 0.06 mm; no greater than 0.04 mm; or no greater than 0.02 mm.

In various implementations, exemplary oxygen carriers may have a particle density from 1000-5000 kg/m³. In various implementations, exemplary oxygen carriers may have a particle density from 1000 kg/m³ to 4900 kg/m³; 1000 kg/m³ to 4800 kg/m³; 1000 kg/m³ to 4700 kg/m³; 1000 kg/m³ to 4600 kg/m³; 1000 kg/m³ to 4500 kg/m³; 1100 kg/m³ to 4500 kg/m³; 1200 kg/m³ to 4500 kg/m³; 1300 kg/m³ to 4500 kg/m³; 1400 kg/m³ to 4500 kg/m³; 1500 kg/m³ to 4500 kg/m³; 1600 kg/m³ to 4500 kg/m³; 1700 kg/m³ to 4500 kg/m³; 1800 kg/m³ to 4500 kg/m³; 1900 kg/m³ to 4500 kg/m³; 2000 kg/m³ to 4500 kg/m³; 2000 kg/m³ to 4000 kg/m³; 2500 kg/m³ to 4000 kg/m³; 2500 kg/m³ to 3500 kg/m³; or about 3000 kg/m³. In various implementations, exemplary oxygen carriers may have a particle density of no less than 1000 kg/m³; no less than 1200 kg/m³; no less than 1400 kg/m³; no less than 1600 kg/m³; no less than 1800 kg/m³; no less than 2000 kg/m³; no less than 2200 kg/m³; no less than 2400 kg/m³; no less than 2600 kg/m³; no less than 2800 kg/m³; no less than 3000 kg/m³; no less than 3200 kg/m³; no less than 3400 kg/m³; no less than 3600 kg/m³; no less than 3800 kg/m³; no less than 4000 kg/m³; no less than 4200 kg/m³; no less than 4400 kg/m³; no less than 4600 kg/m³; or no less than 4800 kg/m³. In various implementations, exemplary oxygen carriers may have a particle density of no greater than 5000 kg/m³; no greater than 4900 kg/m³; no greater than 4700 kg/m³; no greater than 4500 kg/m³; no greater than 4300 kg/m³; no greater than 4100 kg/m³; no greater than 3900 kg/m³; no greater than 3700 kg/m³; no greater than 3500 kg/m³; no greater than 3300 kg/m³; no greater than 3100 kg/m³; no greater than 2900 kg/m³; no greater than 2700 kg/m³; no greater than 2500 kg/m³; no greater than 2300 kg/m³; no greater than 2100 kg/m³; no greater than 1900 kg/m³; no greater than 1700 kg/m³; no greater than 1500 kg/m³; or no greater than 1300 kg/m³.

### D. Exemplary Hydrogen Gas Products and Waste Gases

Generally, exemplary hydrogen gas products are the product of an exemplary hydrogen separation unit. Exemplary hydrogen gas products may include hydrogen gas (H₂) and trace amounts of exemplary waste gases.

Generally, exemplary waste gases are the products generated in exemplary sulfidation and regeneration systems.

In various implementations, exemplary waste gases may comprise carbon dioxide (CO₂), carbon monoxide (CO), carbonyl sulfide (COS), ammonia (NH₃), methane (CH₄), lower hydrocarbons (e.g., C2-C4), higher hydrocarbons (e.g., benzene, toluene, and xylene), or any combinations thereof.

### E. Exemplary Oxygen-Source Gas

Exemplary oxygen-source gases may be used for the oxidation of reduced oxygen carriers. Exemplary oxygen-source gases may comprise oxygen (O₂) and nitrogen (N₂).

### III. Exemplary Systems

Various exemplary systems for hydrogen sulfide (H₂S) conversion to hydrogen gas (H₂) and sulfur (S) are described below. The various exemplary systems disclosed and contemplated herein may be scaled without reducing the performance of the exemplary systems.

In various implementations, a cyclic process is contemplated and disclosed herein for the conversion of hydrogen sulfide (H₂S) to hydrogen gas (H₂) and sulfur (S). Decomposition of hydrogen sulfide (H₂S) occurs in an exemplary sulfidation and regeneration system. In various implementations, the exemplary sulfidation and regeneration system may comprise an exemplary sulfidation reactor (R1) and an exemplary regeneration reactor (R2).

In the sulfidation operations, a hydrogen sulfide (H₂S) feedstock is provided to the exemplary sulfidation reactor (R1), and the hydrogen sulfide (H₂S) feedstock reacts with a plurality of sulfur lean metal sulfide particles, which generates a plurality of sulfur rich metal sulfide particles, hydrogen gas (H₂), and waste gas. During sulfidation operations, the sulfur lean metal sulfide particles capture sulfur (S). The hydrogen gas (H₂) and waste gas are provided from an outlet of the sulfidation reactor (R1) to an inlet of an exemplary hydrogen separation unit.

In various implementations, the sulfur rich metal sulfide particles may be provided from an outlet of the exemplary sulfidation reactor (R1) to an inlet of the exemplary regeneration reactor (R2). The sulfur rich metal sulfide particles are reacted with heat and an inert gas, generating a plurality of sulfur lean metal sulfide particles, inert gas, and sulfur (S). In various implementations, the inert gas may include nitrogen (N₂), argon (Ar), helium (He), or carbon dioxide (CO₂). The inert gas and the sulfur (S) are provided from an outlet of the exemplary regeneration reactor (R2) to an exemplary sulfur condenser.

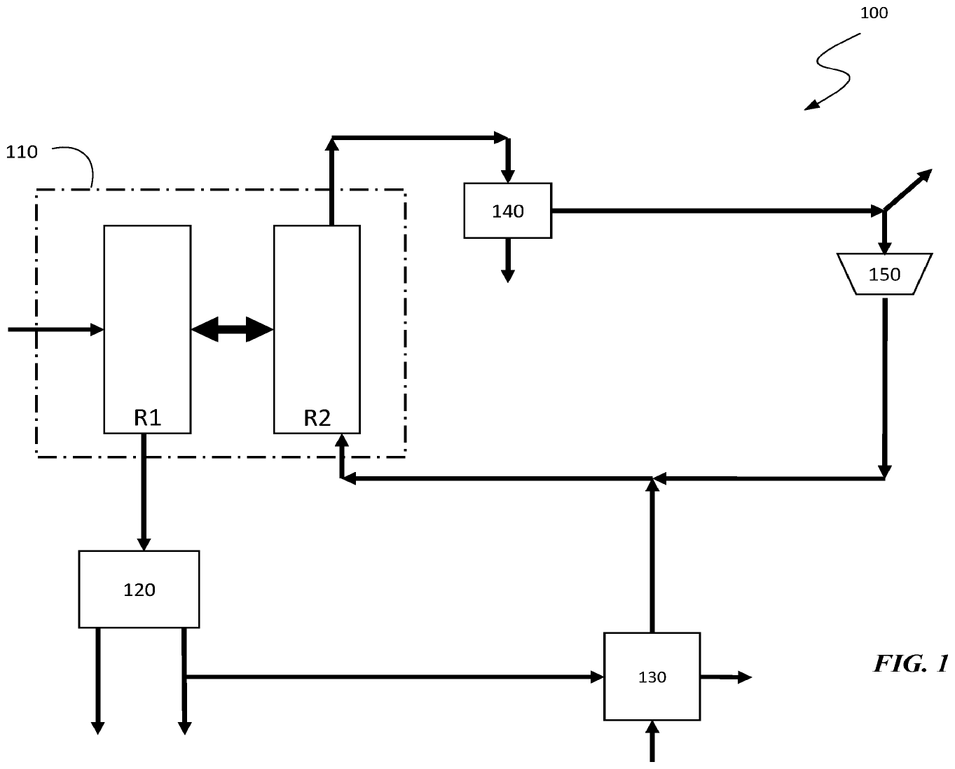

Referring to FIGS. 1-5, sulfidation and regeneration system 110 comprises a plurality of reactors. Typically, sulfidation and regeneration system 110 comprises an exemplary sulfidation reactor (R1) and an exemplary regeneration reactor (R2).

FIG. 1 schematically shows an exemplary system 100 for hydrogen sulfide (H₂S) conversion to hydrogen gas (H₂) and sulfur (S). System 100 comprises a sulfidation and regeneration system 110, hydrogen separation unit 120, nitrogen separation system 130, sulfur condenser 140, and blower 150. Other embodiments may include more or fewer components.

Sulfidation and regeneration system 110 includes a first inlet in fluid communication with a hydrogen sulfide (H₂S) feedstock stream. Sulfidation and regeneration system 110 includes a first outlet in fluid communication with an inlet of sulfur condenser 140. Sulfidation and regeneration system 110 includes a second outlet in fluid communication with an inlet of hydrogen separation unit 120. Sulfidation and regeneration system also 110 includes a second inlet in fluid communication with a nitrogen gas (N₂) stream.

As shown, the hydrogen sulfide (H₂S) feedstock is provided to the first inlet of sulfidation and regeneration system 110. The hydrogen sulfide feedstock is catalytically decomposed with the sulfur lean metal sulfide particles, as described above.

In the implementation shown, the nitrogen gas (N₂) and the sulfur gas (S) are provided from a first outlet of sulfidation and regeneration system 110 to an inlet of sulfur condenser 140.

In the implementation shown, the hydrogen gas (H₂) product and the waste gas are provided from a second outlet of sulfidation and regeneration system 110 to an inlet of hydrogen separation unit 120.

Hydrogen separation unit 120 separates hydrogen gas (H₂) product from the waste gas. Any suitable separation unit capable of separating hydrogen gas (H₂) from waste gas may be used. Hydrogen separation unit 120 includes an inlet in fluid communication with sulfidation and regeneration system 110. Hydrogen separation unit 120 includes a first outlet configured to provide a hydrogen gas (H₂) product stream. Hydrogen separation unit 120 also includes a second outlet configured to provide a waste gas stream.

In various implementations, hydrogen separation unit 120 operates with an efficiency between about 70% to 99% to separate the hydrogen gas (H₂) product from the waste gas. In various implementations, hydrogen separation unit 120 operates with an efficiency between about 70% to about 99%; 75% to 99%; 80% to 99%; 85% to 99%; 90%; to 99%; or 95% to 99%. In various implementations, hydrogen separation unit 120 operates with an efficiency of no less than 70%; no less than 80%; or no less than 90%. In various implementations, the hydrogen separation unit operates with an efficiency of no greater than 99%; no greater than 95%; no greater than 90%; no greater than 85%; no greater than 80%; or no greater than 75%.

Nitrogen separation system 130 separates nitrogen gas (N₂) from oxygen (O₂). Nitrogen separation system 130 includes a first inlet in fluid communication with a slip stream from either the first outlet or the second outlet of hydrogen separation unit 120. Nitrogen separation system 130 includes a second inlet in fluid communication with an oxygen-source stream. Nitrogen separation system 130 also includes a first outlet configured to provide steam (H₂O), carbon dioxide (CO₂), or oxygen (O₂), or combinations thereof. Nitrogen separation system 130 includes a second outlet in fluid communication with the nitrogen gas (N₂) stream.

Sulfur condenser 140 separates sulfur gas (S) from nitrogen gas (N₂). Sulfur condenser 140 includes an inlet in fluid communication with the first inlet of sulfidation and regeneration system 110. Sulfur condenser 140 includes a first outlet configured to provide sulfur gas (S). Sulfur condenser 140 also includes a second outlet in fluid communication with blower 150.

In various implementations, there may be nitrogen gas (N₂) loss between the first outlet and the second inlet of sulfidation and regeneration system 110. Without being bound to any particular theory, the nitrogen gas (N₂) loss may be attributed to piping loss and/or material construction.

Blower 150 pressurizes the nitrogen gas (N₂) from sulfur condenser 140. Blower 150 includes an inlet in fluid communication with the second outlet of sulfur condenser 140. Blower 150 also includes an outlet in fluid communication with the second inlet of sulfidation and regeneration system 110. As shown, the nitrogen gas (N₂) is provided from the outlet of blower 150 to the second inlet of sulfidation and regeneration system 110.

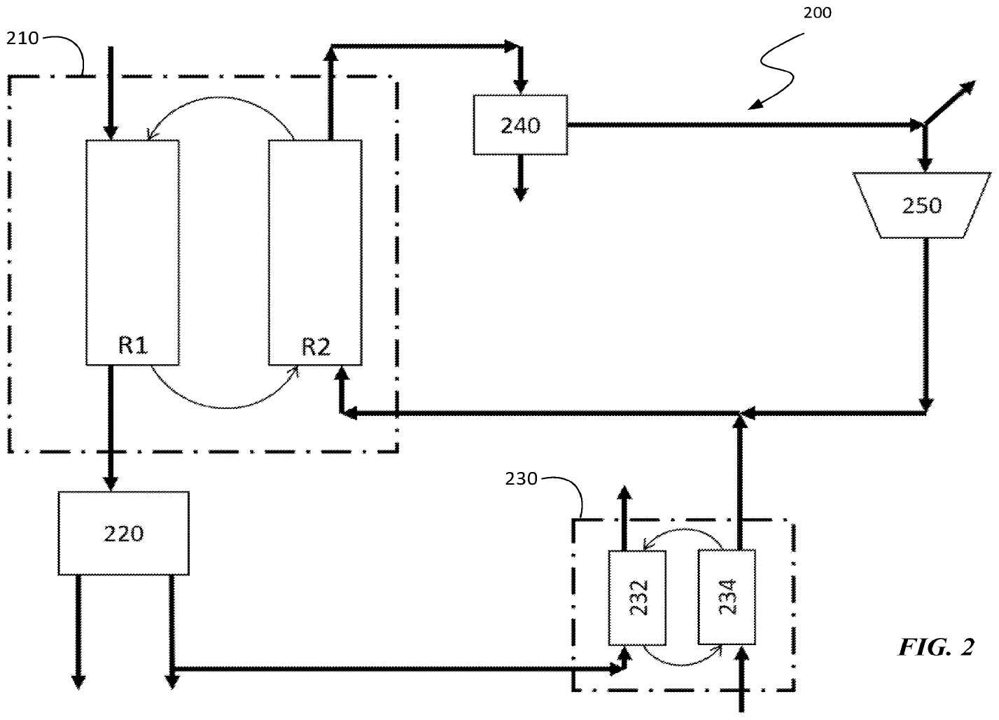

FIG. 2 schematically shows exemplary reactor system 200 for hydrogen sulfide (H₂S) conversion to hydrogen gas (H₂) and sulfur (S). Unless otherwise indicated, and for the sake of brevity, components in FIG. 2 have the same or similar arrangement and operation as those similarly numbered in reactor system 100 shown in FIG. 1. Reactor system 200 comprises sulfidation and regeneration system 210, hydrogen separation unit 220, first reactor 232, second reactor 234, sulfur condenser 240, and blower 250. Other embodiments may include more or fewer components.

First reactor 232 includes a first inlet in fluid communication with a slip stream from either the hydrogen gas (H₂) product stream or the waste gas stream provided from the hydrogen separation unit 220, as described above. First reactor 232 includes a first outlet configured to provide steam (H₂O), carbon dioxide (CO₂), and/or oxygen (O₂), or combinations thereof. First reactor 232 also includes a second inlet configured to receive a plurality of oxidized oxygen carriers. First reactor 232 also includes a second outlet configured to provide a plurality of reduced oxygen carriers.

First reactor 232 may be configured as a fixed bed reactor, a fluidized bed reactor, a co-current moving bed reactor, or a counter-current moving bed reactor. In various implementations, the moving bed reactor may be packed moving bed reactor, a staged fluidized bed reactor, a downer reactor, or a rotary kiln.

In the implementation shown, either the hydrogen gas (H₂) product stream or the waste gas is provided from a first or second outlet of hydrogen separation unit 220. In various implementations, a slip stream is in fluid communication with either of the hydrogen gas (H₂) product stream or the waste gas stream.

In various implementations, the hydrogen gas (H₂) product stream is provided to the first inlet of first reactor 232. The hydrogen gas (H₂) product reacts with the plurality of oxidized oxygen carriers to form steam (H₂O) and the plurality of reduced oxygen carriers. The steam (H₂O) is provided from a first outlet of first reactor 232.

In the implementation shown, the plurality of reduced oxygen carriers is provided from the second outlet of first reactor 232 to the second inlet of second reactor 234.

In various implementations, the waste gas stream is provided to the first inlet of first reactor 232. The waste gas stream reacts with the plurality of oxidized oxygen carriers to form steam (H₂O), carbon dioxide (CO₂), or combinations thereof, and generates a plurality of reduced oxygen carriers. The steam (H₂O), the carbon dioxide (CO₂), or combinations thereof, are provided from the first outlet of first reactor 232.

In the implementation shown, the plurality of reduced oxygen carriers is provided from second outlet of first reactor 232 to the second inlet of second reactor 234.

Second reactor 234 is in fluid communication with an oxygen-source input stream. As shown, the first inlet of second reactor 234 is configured to receive oxygen-source material comprising nitrogen gas (N₂) and oxygen gas (O₂). The oxygen-source material reacts with the plurality of reduced oxygen carriers to regenerate the plurality of reduced oxygen carriers to oxidized oxygen carriers.

Second reactor 234 includes an outlet in fluid communication with the sulfidation and regeneration system 210. In the implementation shown, the second outlet of second reactor 234 is configured to provide the nitrogen gas (N₂). In various implementations, the second outlet of second rector 234 is in fluid communication with the second inlet of sulfidation and regeneration system 210. In various implementations, the second outlet of second reactor 240 is in fluid communication with the nitrogen gas (N₂) stream provided from the outlet of blower 260 to the sulfidation and regeneration system 210.

Second reactor 234 also includes a second inlet in fluid communication with an outlet of first reactor 232. Second reactor 234 also includes a second outlet in fluid communication with the second inlet of the first reactor 232. In the implementation shown, the plurality of oxidized oxygen carriers is provided from the second outlet of second reactor 234 to the second inlet of first reactor 232.

Second reactor 234 may be configured as a fixed bed reactor, a fluidized bed reactor, a co-current moving bed reactor, or a counter-current moving bed reactor. In various implementations, the moving bed reactor may be packed moving bed reactor, a staged fluidized bed reactor, a downer reactor, or a rotary kiln.

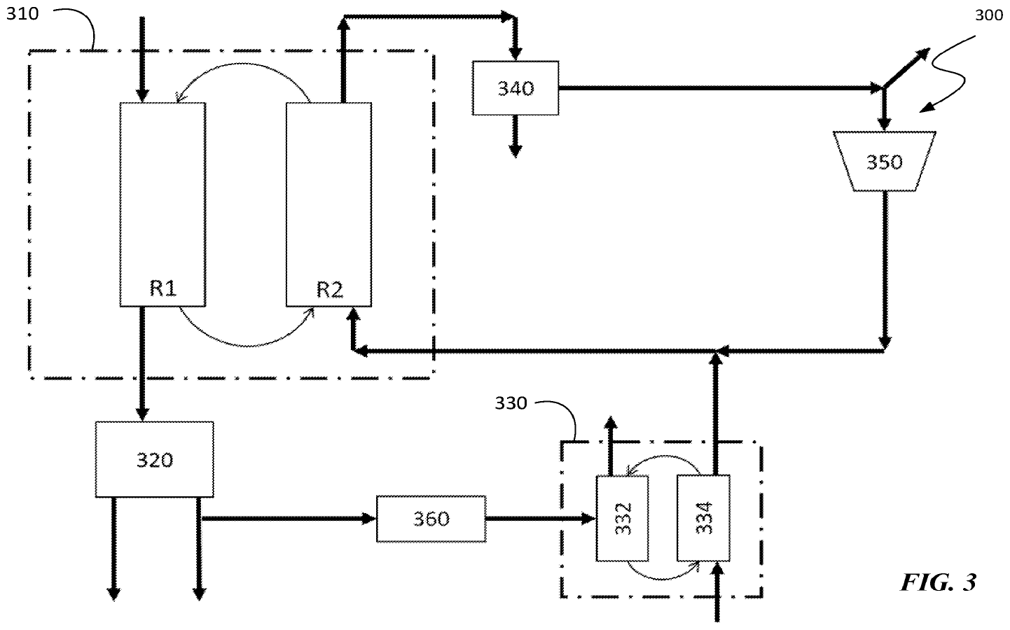

FIG. 3 schematically shows exemplary reactor system 300 for hydrogen sulfide (H₂S) conversion to hydrogen gas (H₂) and sulfur (S). Unless otherwise indicated, and for the sake of brevity, components in FIG. 3 have the same or similar arrangement and operation as those similarly numbered in reactor 100 shown in FIG. 1. Reactor system 300 comprises sulfidation and regeneration system 310, hydrogen separation unit 320, furnace 360, first reactor 332, second reactor 334, sulfur condenser 340, and blower 350. Other embodiments may include more or fewer components.

Furnace 360 combusts the first output from hydrogen separation unit 320. Furnace 360 includes a first inlet in fluid communication with a slip stream from the waste gas stream provided from the hydrogen separation unit 320, as described above. Furnace 360 includes a first outlet configured to heat to a first inlet of the first reactor 332.

In the implementation shown, the heat is provided to first reactor 332, where the heat thermally decomposes the plurality of oxidized oxygen carriers to generate oxygen gas (O₂) and the plurality of the reduced oxygen carriers.

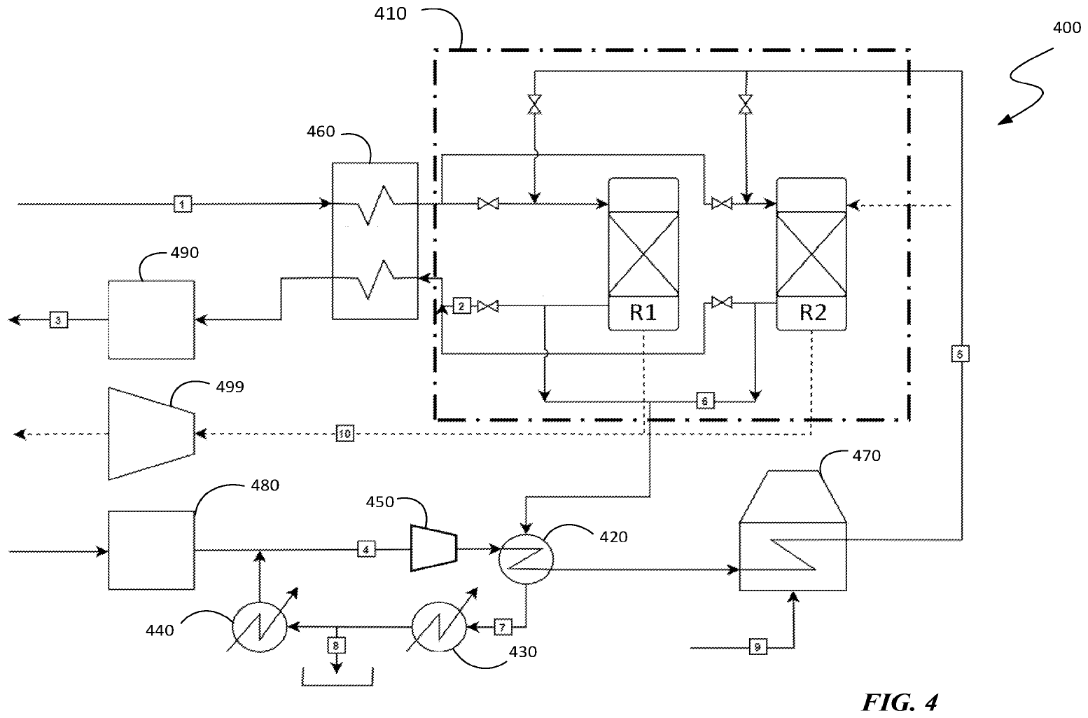

FIG. 4 schematically shows exemplary reactor system 400 for hydrogen sulfide (H₂S) conversion to hydrogen gas (H₂) and sulfur (S). Reactor system 400 includes sulfidation and regeneration system 410, first heat exchanger 420, sulfur condenser 430, cooler 440, blower 450, second heat exchanger 460, furnace 470, air separation unit (ASU) 480, pressure swing adsorption unit (PSAU) 490, and steam turbine 499. Other embodiments may include more or fewer components.

Sulfidation and regeneration system 410 includes a first inlet in fluid communication with a hot outlet of second heat exchanger 460. As used herein, a “hot” input/output stream is used to denote the stream in a heat exchanger that provides thermal energy to the “cold” input/output stream. Accordingly, “hot” and “cold” are used as relative terms only. The “hot” input has a greater temperature than the “hot” output; and the “cold” input has a lower temperature than the “cold” output.

Sulfidation and regeneration system 110 includes a first outlet in fluid communication with a hot inlet of first heat exchanger 420. Sulfidation and regeneration system 110 includes a second outlet in fluid communication with an inlet of first heat exchanger 460. Sulfidation and regeneration system 110 also includes a second inlet in fluid communication with an outlet of furnace 470.

In the implementation shown, sulfidation and regeneration system 410 may include a third inlet in fluid communication with a steam stream. In the implementation shown, sulfidation and regeneration system 410 may include a third outlet in fluid communication with an inlet of steam turbine 499.

In the implementation shown, the hydrogen sulfide (H₂S) feedstock is provided to the first inlet of sulfidation and regeneration system 110. The hydrogen sulfide feedstock is catalytically decomposed with the plurality of sulfur lean metal sulfide particles, as described above.

In the implementation shown, the nitrogen gas (N₂) is provided to a second inlet of sulfidation and regeneration system 410.

In the implementation shown, the nitrogen gas (N₂) and the sulfur gas (S) are provided from a first outlet of sulfidation and regeneration system 110 to the hot inlet of first heat exchanger 420.

In the implementation shown, the desulfurized hydrogen-containing gas (H₂) is provided from a second outlet of sulfidation and regeneration system 110 to a hot inlet of second heat exchanger 460.

First heat exchanger 420 transfers heat from a hot stream to a cold stream. First heat exchanger 420 includes a hot stream inlet in fluid communication with the first outlet of sulfidation and regeneration system 410. First heat exchanger includes a cold stream outlet in fluid communication with sulfur condenser 420. First heat exchanger 420 includes a cold stream inlet in fluid communication with blower 450. First heat exchanger includes a hot stream outlet in fluid communication with a first inlet of furnace 470.

In the implementation shown, cooled nitrogen gas (N₂) and sulfur gas (S) is provided from the first outlet of first heat exchanger to an inlet of sulfur condenser 430.

In the implementation shown, hot nitrogen gas (N₂) is provided from the second outlet of first heat exchanger 420 to a first inlet of furnace 470.

Sulfur condenser 430 separates sulfur gas (S) from nitrogen gas (N₂). Sulfur condenser 430 includes an inlet in fluid communication with first heat exchanger 420. Sulfur condenser 430 includes a first outlet configured to provide sulfur gas (S) to a sulfur collection unit, such as a sulfur pit. Sulfur condenser 430 also includes a second outlet in fluid communication with cooler 440.

In the implementation shown, sulfur condenser 430 provides nitrogen gas (N₂) to an inlet of cooler 440.

Cooler 440 cools the nitrogen gas (N₂) provided from sulfur condenser 430 and provides nitrogen gas (N₂) to an inlet of blower 450. Cooler 440 includes an inlet in fluid communication with sulfur condenser 430. Cooler 440 also includes an outlet in fluid communication with a nitrogen gas (N₂) input stream.

Blower 450 pressurizes the nitrogen gas (N₂) input stream. Blower 450 includes an inlet in fluid communication with an outlet of ASU 480. Blower 450 also includes an outlet in fluid communication with a cold stream inlet of first heat exchanger 420.

Furnace 470 combusts natural gas to heat the nitrogen gas (N₂) input stream), Furnace 470 includes a first inlet in fluid communication with the hot stream outlet of first heat exchanger 420. Furnace 470 includes a second inlet in fluid communication with a natural gas stream. Furnace 470 also includes an outlet in fluid communication with the second inlet of sulfidation and regeneration system 410.

In the implementation shown, first heat exchanger 420 provides hot nitrogen gas (N₂) to an inlet of furnace 470.

In the implementation shown, the hot nitrogen gas (N₂) is provided from the outlet of furnace 470 to the second inlet of the sulfidation and regeneration system 410.

Second heat exchanger 460 transfers heat from a hot stream to a cold stream. Second heat exchanger 460 includes a cold stream inlet in fluid communication with a hydrogen sulfide (H₂S) feedstock. Second heat exchanger 460 includes a hot stream inlet in fluid communication with the second outlet of sulfidation and regeneration system. Second heat exchanger 460 also includes a hot stream outlet in fluid communication with the first inlet of sulfidation and regeneration system 410. Second heat exchanger 460 also includes a cold stream outlet in fluid communication with an inlet of PSAU 490.

ASU 480 separates nitrogen gas (N₂) from an air stream. ASU 480 includes an inlet in fluid communication with an air stream. ASU 480 includes an outlet in fluid communication with the inlet of blower 450. ASU 480 is configured to separate nitrogen gas (N₂) from oxygen (O₂) and any remaining constituents of air.

PSAU 490 separates hydrogen gas (H₂) from a desulfurized hydrogen gas stream. PSAU 490 includes an inlet in fluid communication with a cold stream outlet of second heat exchanger 460. PSAU includes an outlet configured to provide hydrogen gas (H₂).

Steam turbine 499 generates energy from high-pressure steam. Steam turbine 499 includes an inlet in fluid communication with a third outlet from sulfidation and regeneration system 410. Steam turbine 499 includes an outlet configured to provide medium pressure steam.

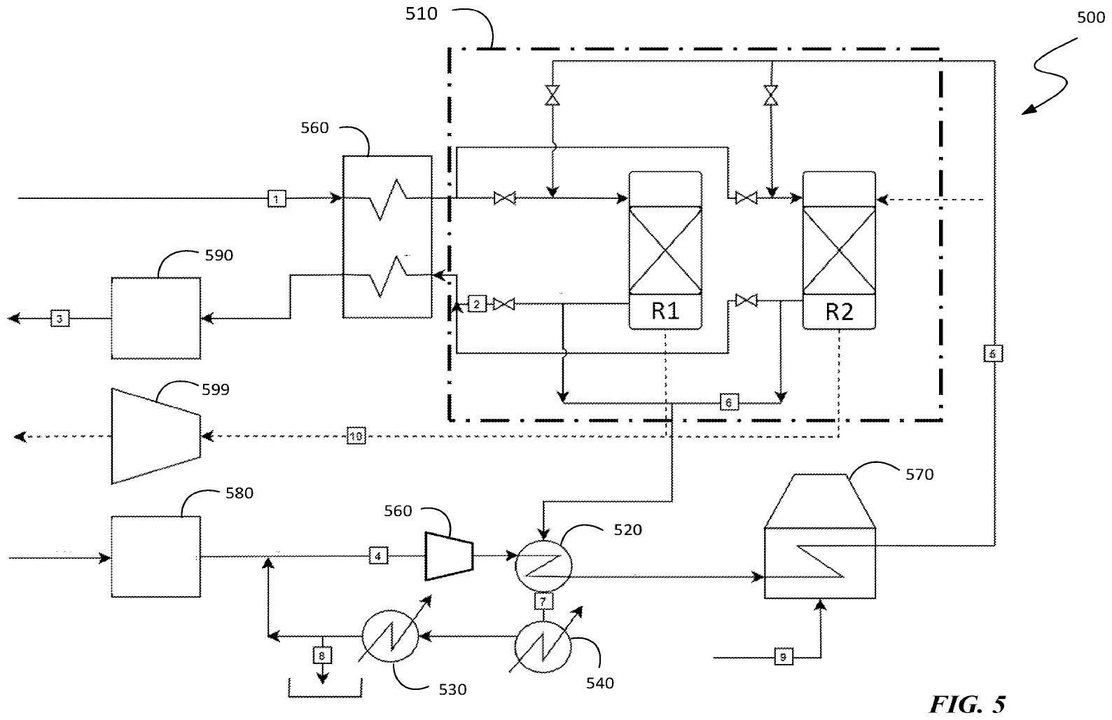

FIG. 5 shows exemplary reactor system 500 for hydrogen sulfide (H₂S) conversion to hydrogen gas (H₂) and sulfur (S). Unless otherwise indicated, and for the sake of brevity, components in FIG. 5 have the same or similar arrangement and operation as those similarly numbered in reactor system 400 shown in FIG. 4. Reactor system 500 comprises sulfidation and regeneration system 510, first heat exchanger 520, sulfur condenser 530, steam generator 440, blower 560, second heat exchanger 560, furnace 570, air separation unit (ASU) 580, pressure swing adsorption unit (PSAU) 590, and steam turbine 599. Other embodiments may include more or fewer components.

Steam generator 540 generates steam and cools a stream of nitrogen gas (N₂) and sulfur gas (S). Steam generator 540 includes an inlet in fluid communication with the cold stream outlet of first heat exchanger 520. Steam generator 540 also includes an outlet in fluid communication with the inlet of sulfur condenser 530. Steam generator 540 is configured to lower the temperature of the nitrogen gas (N₂) and sulfur gas (S) before being provided to sulfur condenser 530.

In the implementation shown, the nitrogen gas (N₂) and sulfur gas (S) is provided from the outlet of steam generator 540 to the inlet of sulfur condenser 530.

### IV. Exemplary Methods of Operation

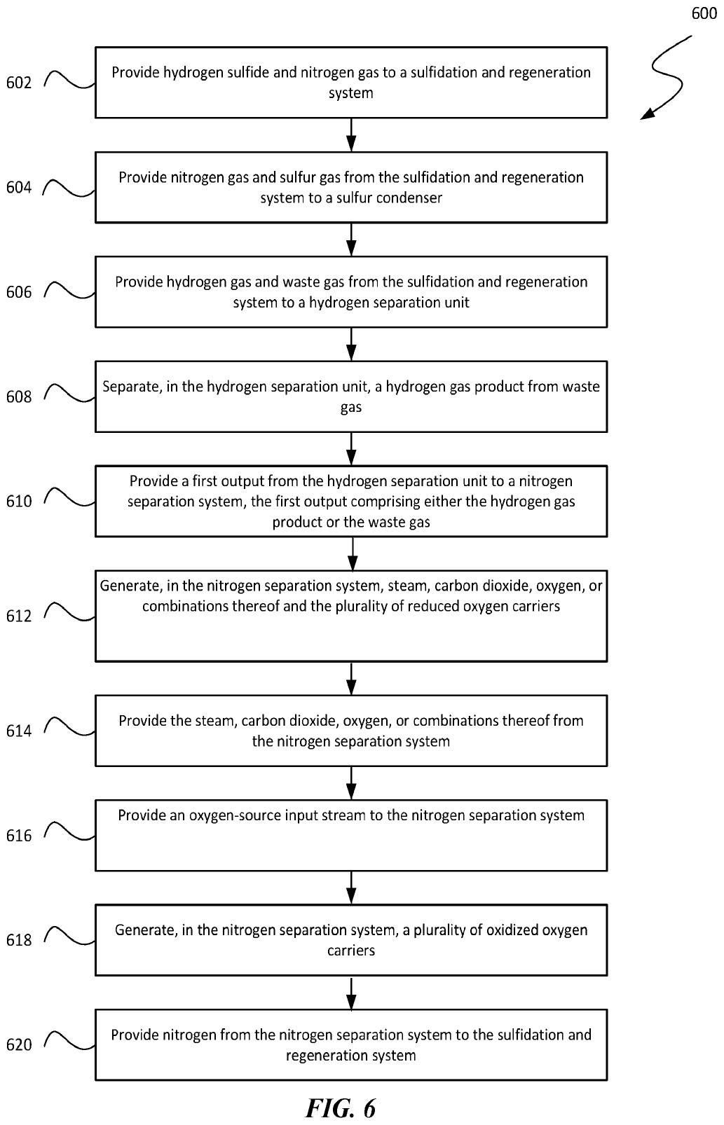

Exemplary methods of hydrogen sulfide (H₂S) conversion to hydrogen gas (H₂) and sulfur (S) may comprise various operations. FIG. 6 shows example method 600 for operating a reactor system. As shown, method 600 includes providing hydrogen sulfide (H₂S) and nitrogen gas (N₂) to a sulfidation and regeneration system (operation 602), providing nitrogen gas (N₂) and sulfur gas (S) from a first outlet of the sulfidation and regeneration system to an inlet of a sulfur condenser (operation 604), providing hydrogen gas (H₂) and waste gas from a second outlet of the sulfidation and regeneration system to an inlet of a hydrogen separation unit (operation 606), separating, in the hydrogen separation unit, a hydrogen gas product from waste gas (operation 608), providing a first output from the hydrogen separation unit to first inlet of a nitrogen separation system, the first output comprising either the hydrogen gas product or the waste gas (operation 610), providing an oxygen-source input stream to a second inlet of the nitrogen separation system, the oxygen-source input stream comprising nitrogen and oxygen (operation 612), generating, in the nitrogen separation system, a plurality of oxidized oxygen carriers by contacting oxygen with a plurality of reduced oxygen carriers (operation 614), providing nitrogen from a first outlet of the nitrogen separation system to the sulfidation and regeneration system (operation 616), generating, in the nitrogen separation system, steam (H₂O), carbon dioxide (CO₂), oxygen (O₂), or combinations thereof and the plurality of reduced oxygen carriers by reacting the first output from the hydrogen separation unit with the plurality of oxidized oxygen carriers (operation 618), and providing the steam (H₂O), carbon dioxide (CO₂), oxygen (O₂), or combinations thereof from a second outlet of the nitrogen separation system (operation 620). Other embodiments may include more or fewer operations. Exemplary systems described and contemplated herein can be utilized to perform operations of method 600.

Method 600 may begin by providing hydrogen sulfide (H₂S) and nitrogen gas (N₂) to the sulfidation and regeneration system (operation 602). The sulfidation and regeneration system may operate to convert hydrogen sulfide (H₂S) to hydrogen gas (H₂) and sulfur gas (S).

In various implementations, the sulfidation reactor may be operated at a temperature of about 100° C. to about 950° C.; about 150° C. to about 950° C.; about 200 to about 950° C.; about 250° C. to about 950° C.; about 300° C. to about 950° C.; about 350° C. to about 950° C.; about 400° C. to 950° C.; about 450° C. to about 950° C.; about 500° C. to about 950° C.; about 550° C. to about 950° C.; about 600° C. to about 950° C.; about 650° C. to about 950° C.; about 700° C. to about 950° C.; about 750° C. to about 950° C.; about 800° C. to about 950° C.; about 850° C. to about 950° C.; or about 900° C. to about 950° C. In various implementations, the sulfidation reactor may be operated at a temperature of no less than 100° C.; no less than 150° C.; no less than 250° C.; no less than 350° C.; no less than 450° C.; no less than 550° C.; no less than 650° C.; no less than 750° C.; or no less than 850° C. In various implementations, the sulfidation reactor may be operated at a temperature of no greater than 950° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; no greater than 225° C.; no greater than 175° C.; or no greater than 125° C.

In various implementations, the sulfidation reactor may be operated at a pressure between about 0.01 MPa to about 15 MPa; 0.01 MPa to 14 MPa; 0.01 MPa to 13 MPa; 0.01 MPa to 12 MPa; 0.01 MPa to 11 MPa; 0.01 MPa to 10 MPa; 0.01 MPa to 9 MPa; 0.01 MPa to 8 MPa; 0.01 MPa to 7 MPa; 0.01 MPa to 6 MPa; 0.01 MPa to 5 MPa; 0.01 MPa to 4 MPa; 0.01 MPa to 3 MPa; 0.01 MPa to 2 MPa; 0.01 MPa to 1 MPa; 0.1 MPa to 15 MPa; 1 MPa to 15 MPa; 2 MPa to 15 MPa; 3 MPa to 15 MPa; 4 MPa to 15 MPa; 5 MPa to 15 MPa; 6 MPa to 15 MPa; 7 MPa to 15 MPa; 8 MPa to 15 MPa; 9 MPa to 15 MPa; 10 MPa to 15 MPa; 11 MPa to 15 MPa; 12 MPa to 15 MPa; 13 MPa to 15 MPa; 14 MPa to 15 MPa or about 15 MPa. In various implementations, the sulfidation reactor may be operated at a pressure of no less than 0.01 MPa; no less than 0.1 MPa; no less than 1 MPa; no less than 3 MPa; no less than 5 MPa; no less than 7 MPa; no less than 9 MPa; no less than 11 MPa; or no less than 13 MPa. In various implementations, the sulfidation reactor may be operated at a pressure of no greater than 15 MPa; no greater than 14 MPa; no greater than 12 MPa; no greater than 10 MPa; no greater than 8 MPa; no greater than 6 MPa; no greater than 4 MPa; no greater than 2 MPa; no greater than 0.5 MPa; or no greater than 0.05 MPa.

In various implementations, the regeneration reactor may be operated at temperature of about 100° C. to about 1500° C.; about 150° C. to about 1500° C.; about 200 to about 1500° C.; about 250° C. to about 1500° C.; about 300° C. to about 1500° C.; about 350° C. to about 1500° C.; about 400° C. to 1500° C.; about 450° C. to about 1500° C.; about 500° C. to about 1500° C.; about 550° C. to about 1500° C.; about 600° C. to about 1500° C.; about 650° C. to about 1500° C.; about 700° C. to about 1500° C.; about 750° C. to about 1500° C.; about 800° C. to about 1500° C.; about 850° C. to about 1500° C.; about 900° C. to about 1500° C.; about 1000° C. to about 1500° C.; or about 1250° C. to about 1500° C. In various implementations, the sulfidation reactor may be operated at a temperature of no less than 100° C.; no less than 150° C.; no less than 250° C.; no less than 350° C.; no less than 450° C.; no less than 550° C.; no less than 650° C.; no less than 750° C.; no less than 850° C.; no less than 950° C.; no less than 1050° C.; no less than 1150° C.; no less than 1250° C.; no less than 1350° C.; or no less than 1450° C. In various implementations, the sulfidation reactor may be operated at a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; no greater than 225° C.; no greater than 175° C.; or no greater than 125° C.

In various implementations, the regeneration reactor may be operated at a pressure between about 0.01 MPa to about 15 MPa; 0.01 MPa to 14 MPa; 0.01 MPa to 13 MPa; 0.01 MPa to 12 MPa; 0.01 MPa to 11 MPa; 0.01 MPa to 10 MPa; 0.01 MPa to 9 MPa; 0.01 MPa to 8 MPa; 0.01 MPa to 7 MPa; 0.01 MPa to 6 MPa; 0.01 MPa to 5 MPa; 0.01 MPa to 4 MPa; 0.01 MPa to 3 MPa; 0.01 MPa to 2 MPa; 0.01 MPa to 1 MPa; 0.1 MPa to 15 MPa; 1 MPa to 15 MPa; 2 MPa to 15 MPa; 3 MPa to 15 MPa; 4 MPa to 15 MPa; 5 MPa to 15 MPa; 6 MPa to 15 MPa; 7 MPa to 15 MPa; 8 MPa to 15 MPa; 9 MPa to 15 MPa; 10 MPa to 15 MPa; 11 MPa to 15 MPa; 12 MPa to 15 MPa; 13 MPa to 15 MPa; 14 MPa to 15 MPa or about 15 MPa. In various implementations, the regeneration reactor may be operated at a pressure of no less than 0.01 MPa; no less than 0.1 MPa; no less than 1 MPa; no less than 3 MPa; no less than 5 MPa; no less than 7 MPa; no less than 9 MPa; no less than 11 MPa; or no less than 13 MPa. In various implementations, the regeneration reactor may be operated at a pressure of no greater than 15 MPa; no greater than 14 MPa; no greater than 12 MPa; no greater than 10 MPa; no greater than 8 MPa; no greater than 6 MPa; no greater than 4 MPa; no greater than 2 MPa; no greater than 0.5 MPa; or no greater than 0.05 MPa.

The nitrogen gas (N₂) and sulfur gas (S) are provided from a first outlet of the sulfidation and regeneration system to an inlet of the sulfur condenser (operation 604). The first outlet of the sulfidation and regeneration system is in fluid communication with an inlet of the sulfur condenser.

The hydrogen gas (H₂) and waste gas are provided from a second outlet of the sulfidation and regeneration system to an inlet of the hydrogen separation unit (operation 606). The second inlet of the sulfidation and regeneration system is in fluid communication with the inlet of the hydrogen separation unit.

Hydrogen gas (H₂) product is separated from waste gas in the hydrogen separation unit (operation 608).

In various implementations, the hydrogen separation unit may be operated a temperature between about 40° C. to about 80° C.; about 45° C. to about 80° C.; about 50° C. to about 80° C.; about 55° C. to about 80° C.; about 60° C. to about 80° C.; about 65° C. to about 80° C.; about 70° C. to about 80° C.; about 75° C. to about 80° C. In various implementations, the hydrogen separation unit may be operated at a temperature of no less than 40° C.; no less than 50° C.; or no less than 60° C. In various implementations, the hydrogen separation unit may be operated at a temperature of no greater than 80° C.; no greater than 75° C.; no greater than 65° C.; no greater than 55° C.; or no greater than 45° C.

In various implementations, the hydrogen separation unit may be operated at a pressure between about 1 MPa to about 8 MPa; 1.5 MPa to 8 MPa; 2 MPa to 8 MPa; 2.5 MPa to 8 MPa; 3 MPa to 8 MPa; 3.5 MPa to 8 MPa; 4 MPa to 8 MPa; 4.5 MPa to 8 MPa; 5 MPa to 8 MPa; 5.5 MPa to 8 MPa; 6 MPa to 8 MPa; 6.5 MPa to 8 MPa; 7 MPa to 8 MPa; 7.5 MPa to 8 MPa; 1 MPa to 7.5 MPa; 1 MPa to 7 MPa; 1 MPa to 6.5 MPa; 1 MPa to 6 MPa; 1 MPa to 5.5 MPa; 1 MPa to 5 MPa; 1 MPa to 4.5 MPa; 1 MPa to 4 MPa; 1 MPa to 3.5 MPa; 1 MPa to 3 MPa; 1 MPa to 2.5 MPa; 1 MPa to 2 MPa; or 1 MPa to 1.5 MPa. In various implementations, the hydrogen separation unit may be operated a pressure of no less than 1 MPa; no less than 2 MPa; no less than 3 MPa; no less than 4 MPa; no less than 5 MPa; no less than 6 MPa; or no less than 7 MPa. In various implementations, the hydrogen separation unit may be operated at a pressure of no greater than 8 MPa; no greater than 7.5 MPa; no greater than 6.5 MPa; no greater than 5.5 MPa; no greater than 4.5 MPa; no greater than 3.5 MPa; no greater than 2.5 MPa; or no greater than 1.5 MPa.

A first output is provided from the hydrogen separation unit to the nitrogen separation system (operation 610). I first output may comprise either the hydrogen gas (H₂) product or the waste gas. The hydrogen separation unit also provides a second output, which may comprise either the hydrogen gas (H₂) product or the waste gas. A slip stream of the first output of the hydrogen separation unit is in fluid communication with the nitrogen separation system.

Various amounts may be drawn off as a slip stream and provided to the nitrogen separation system. In various implementations, the volume percent (vol. %) of the output provided from the hydrogen separation unit to the nitrogen separation system, in terms of the entire output from the hydrogen separation unit, is between about 1 vol. % to about 80 vol. %; about 5 vol. % to about 80 vol. %; about 10 vol. % to about 80 vol. %; about 15 vol. % to about 80 vol. %; about 20 vol. % to about 80 vol. %; about 25 vol. % to about 80 vol. %; about 30 vol. % to about 80 vol. %; about 35 vol. % to about 80 vol. %; about 40 vol. % to about 80 vol. %; about 45 vol. % to about 80 vol. %; about 50 vol. % to about 80 vol. %; about 55 vol. % to about 80 vol. %; about 60 vol. % to about 80 vol. %; about 65 vol. % to about 80 vol. %; about 70 vol. % to about 80 vol. %; about 75 vol. % to about 80 vol. %; about 1 vol. % to 75 vol. %; about 1 vol. % to about 70 vol. %; about 60 vol. %; about 1 vol. % to about 50 vol. %; about 1 vol. % to about 40 vol. %; about 1 vol. % to about 30 vol. %; about 1 vol. % to about 20 vol. %; or about 1 vol. % to about 10 vol. %. In various implementations, the volume percent of the output provided from the hydrogen separation unit to the nitrogen separation system, in terms of the entire output from the hydrogen separation unit, is no less than 1 vol. %; no less than 5 vol. %; no less than 10 vol. %; no less than 15 vol. %; no less than 20 vol. %; no less than 25 vol. %; no less than 30 vol. %; no less than 35 vol. %; no less than 40 vol. %; no less than 45 vol. %; no less than 50 vol. %; no less than 55 vol. %; no less than 60 vol. %; no less than 65 vol. %; no less than 70 vol. %; or no less than 75 vol. %. In various implementations, the volume percent of the output provided from the hydrogen separation unit to the nitrogen separation system, in terms of the entire output from the hydrogen separation unit, is no greater than 80 vol. %; no greater than 78 vol. %; no greater than 72 vol. %; no greater than 68 vol. %; no greater than 62 vol. %; no greater than 58 vol. %; no greater than 52 vol. %; no greater than 48 vol. %; no greater tan 42 vol. %; no greater than 38 vol. %; no greater than 32 vol. %; no greater than 28 vol. %; no greater than 22 vol. %; no greater than 18 vol. %; no greater than 12 vol. %; no greater than 8 vol. %; or no greater than 2 vol. %.

In various implementations, the nitrogen separation system may comprise a first reactor and a second reactor.

In various implementations, the first reactor of the nitrogen separation system is in fluid communication with a slip stream from the first output of the hydrogen separation unit. The first reactor of the nitrogen separation system operates to generate steam (H₂O), oxygen (O₂), and/or carbon dioxide (CO₂) and a plurality of reduced oxygen carriers by reacting a plurality of oxidized oxygen carriers with the first output of the hydrogen separation unit to (operation 612). The first reactor of the nitrogen separation system is in fluid communication with the second reactor of the nitrogen separation system and transports the plurality of reduced oxygen carriers to the second reactor.

The first reactor of the nitrogen separation system provides steam (H₂O), carbon dioxide (CO₂), oxygen (O₂), or combinations thereof from a first outlet (operation 614).

In various implementations, the first reactor of the nitrogen separation system may be operated at temperature of about 100° C. to about 1200° C.; about 150° C. to about 1200° C.; about 200 to about 1200° C.; about 250° C. to about 1200° C.; about 300° C. to about 1200° C.; about 350° C. to about 1200° C.; about 400° C. to 1200° C.; about 450° C. to about 1200° C.; about 500° C. to about 1200° C.; about 550° C. to about 1200° C.; about 600° C. to about 1200° C.; about 650° C. to about 1200° C.; about 700° C. to about 1200° C.; about 750° C. to about 1200° C.; about 800° C. to about 1200° C.; about 850° C. to about 1200° C.; about 900° C. to about 1200° C.; about 1000° C. to about 1200° C.; or about 1100° C. to about 1200° C. In various implementations, the first reactor of the nitrogen separation system may be operated at a temperature of no less than 100° C.; no less than 150° C.; no less than 250° C.; no less than 350° C.; no less than 450° C.; no less than 550° C.; no less than 650° C.; no less than 750° C.; no less than 850° C.; no less than 950° C.; no less than 1050° C.; or no less than 1150° C. In various implementations, the first reactor of the nitrogen separation system may be operated at a temperature of no greater than 1200° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; no greater than 225° C.; no greater than 175° C.; or no greater than 125° C.

In various implementations, the first reactor of the nitrogen separation system may be operated at a pressure between about 0.01 MPa to about 5 MPa; 0.02 MPa to 5 MPa; 0.03 MPa to 5 MPa; 0.04 MPa to 5 MPa; 0.05 MPa to 5 MPa; 0.06 MPa to 5 MPa; 0.07 MPa to 5 MPa; 0.08 MPa to 5 MPa; 0.09 MPa to 5 MPa; 0.09 MPa to 5 MPa; 0.1 MPa to 5 MPa; 0.15 MPa to 5 MPa; 0.2 MPa to 5 MPa; 0.3 MPa to 5 MPa; 0.4 MPa to 5 MPa; 0.5 MPa to 5 MPa; 0.6 MPa to 5 MPa; 0.7 MPa to 5 MPa; 0.8 MPa to 5 MPa; 0.9 MPa to 5 MPa; 1 MPa to 5 MPa; 2 MPa to 5 MPa; 3 MPa to 5 MPa; or 4 MPa to 5 MPa. In various implementations, the first reactor of the nitrogen separation system may be operated at a pressure of no less than 0.01 MPa; no less than 0.05 MPa; no less than 0.07 MPa; no less than 0.09 MPa; no less than 0.3 MPa; no less than 0.5 MPa; no less than 0.7 MPa; no less than 0.9 MPa; no less than 1 MPa; or no less than 3 MPa. In various implementations, the first reactor of the nitrogen separation system may be operated at a pressure of no greater than 5 MPa; no greater than 4 MPa; no greater than 2 MPa; no greater than 1 MPa; no greater than 0.8 MPa; no greater than 0.6 MPa; no greater than 0.4 MPa; no greater than 0.2 MPa; no greater than 0.08 MPa; no greater than 0.06; no greater than 0.04; or no greater than 0.02 MPa.

In various implementations, the first reactor of the nitrogen separation system may be operated with a residence time between about 0.5 seconds to about 30 minutes; 5 seconds to 30 minutes; 15 seconds to 30 minutes; 30 seconds to 30 minutes; 1 minute to 30 minutes; 5 minutes to 30 minutes; 10 minutes to 30 minutes; 15 minutes to 30 minutes; 20 minutes to 30 minutes; or 25 minutes to 30 minutes. In various implementations, the first reactor of the nitrogen separation system may be operated with a residence time of no less than 0.5 seconds; no less than 30 seconds; no less than 2 minutes; no less than 8 minutes; no less than 12 minutes; no less than 18 minutes; no less than 22 minutes; or no less than 28 minutes. In various implementations, the first reactor of the nitrogen separation system may be operated with a residence time no greater than 30 minutes; no greater than 25 minutes; no greater than 20 minutes; no greater than 15 minutes; no greater than 10 minutes; no greater than 5 minutes; no greater than 1 minutes; no greater than 45 seconds; no greater than 15 seconds; or no greater than 5 seconds.

In various implementations, the first output may be provided from the hydrogen separation unit to a furnace and then an output from the furnace is provided to the first reactor of the nitrogen separation system. In these implementations, the first output may comprise waste gas. In various implementations, the furnace may combust the first output comprising the waste gas to generate heat.

In various implementations, the furnace may operate a temperature between of about 50° C. to about 1500° C.; about 100° C. to about 1500° C.; about 150° C. to about 1500° C.; about 200 to about 1500° C.; about 250° C. to about 1500° C.; about 300° C. to about 1500° C.; about 350° C. to about 1500° C.; about 400° C. to 1500° C.; about 450° C. to about 1500° C.; about 500° C. to about 1500° C.; about 550° C. to about 1500° C.; about 600° C. to about 1500° C.; about 650° C. to about 1500° C.; about 700° C. to about 1500° C.; about 750° C. to about 1500° C.; about 800° C. to about 1500° C.; about 850° C. to about 1500° C.; about 900° C. to about 1500° C.; about 1000° C. to about 1500° C.; or about 1250° C. to about 1500° C. In various implementations, the furnace may be operated at a temperature of no less than 50 C; no less than 100° C.; no less than 150° C.; no less than 250° C.; no less than 350° C.; no less than 450° C.; no less than 550° C.; no less than 650° C.; no less than 750° C.; no less than 850° C.; no less than 950° C.; no less than 1050° C.; no less than 1150° C.; no less than 1250° C.; no less than 1350° C.; or no less than 1450° C. In various implementations, the furnace may be operated at a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; no greater than 225° C.; no greater than 175° C.; no greater than 125° C.; or no greater than 75° C.

In various implementations, the furnace may operate at a pressure from about 0.1 MPa to about 1 MPa; about 0.2 MPa; to about 1 MPa; about 0.3 MPa to about 1 MPa; about 0.4 to about 1 MPa; about 0.5 MPa to about 1 MPa; about 0.6 MPa to about 1 MPa; about 0.7 MPa to about 1 MPa; about 0.8 MPa to about 1 MPa; about 0.9 MPa to about 1 MPa. In various implementations, the furnace may operate at a pressure of no less than 0.1 MPa; no less than 0.3 MPa; no less than 0.5 MPa; no less than 0.7; or no less than 0.9 MPa. In various implementations, the furnace may operate at a pressure of no greater than 1 MPa; no greater than 0.8 MPa; no greater than 0.6 MPa; no greater than 0.4 MPa; no greater than 0.2 MPa.

A plurality of reduced oxygen carriers is provided from the first reactor to the second reactor of the nitrogen separation system. An oxygen-source input stream is provided to the second inlet of the second reactor (operation 616). Typically, the oxygen-source input stream comprises nitrogen (N₂) and oxygen (O₂)

The second reactor of the nitrogen separation system operates to generate a plurality of oxidized oxygen carriers and nitrogen gas (N₂) by contacting the plurality of reduced oxygen carriers with oxygen (O₂) (operation 818). The second reactor is fluid communication with the first reactor. A plurality of oxidized oxygen carriers are then provided to the first reactor. The second reactor of the nitrogen separation system is in fluid communication with the sulfidation and regeneration system.

In various implementations, the method 600 may include providing nitrogen gas (N₂) from the second reactor to a nitrogen gas (N₂) stream. Typically, the nitrogen gas (N₂) stream is arranged between an outlet of the blower and an inlet of the sulfidation and regeneration system.

In various implementations, the second reactor of the nitrogen separation system may be operated at temperature of about 100° C. to about 1200° C.; about 150° C. to about 1200° C.; about 200 to about 1200° C.; about 250° C. to about 1200° C.; about 300° C. to about 1200° C.; about 350° C. to about 1200° C.; about 400° C. to 1200° C.; about 450° C. to about 1200° C.; about 500° C. to about 1200° C.; about 550° C. to about 1200° C.; about 600° C. to about 1200° C.; about 650° C. to about 1200° C.; about 700° C. to about 1200° C.; about 750° C. to about 1200° C.; about 800° C. to about 1200° C.; about 850° C. to about 1200° C.; about 900° C. to about 1200° C.; about 1000° C. to about 1200° C.; or about 1100° C. to about 1200° C. In various implementations, the second reactor of the nitrogen separation system may be operated at a temperature of no less than 100° C.; no less than 150° C.; no less than 250° C.; no less than 350° C.; no less than 450° C.; no less than 550° C.; no less than 650° C.; no less than 750° C.; no less than 850° C.; no less than 950° C.; no less than 1050° C.; or no less than 1150° C. In various implementations, the second reactor of the nitrogen separation system may be operated at a temperature of no greater than 1200° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; no greater than 225° C.; no greater than 175° C.; or no greater than 125° C.

In various implementations, the second reactor of the nitrogen separation system may be operated at a pressure between about 0.01 MPa to about 5 MPa; 0.02 MPa to 5 MPa; 0.03 MPa to 5 MPa; 0.04 MPa to 5 MPa; 0.05 MPa to 5 MPa; 0.06 MPa to 5 MPa; 0.07 MPa to 5 MPa; 0.08 MPa to 5 MPa; 0.09 MPa to 5 MPa; 0.09 MPa to 5 MPa; 0.1 MPa to 5 MPa; 0.15 MPa to 5 MPa; 0.2 MPa to 5 MPa; 0.3 MPa to 5 MPa; 0.4 MPa to 5 MPa; 0.5 MPa to 5 MPa; 0.6 MPa to 5 MPa; 0.7 MPa to 5 MPa; 0.8 MPa to 5 MPa; 0.9 MPa to 5 MPa; 1 MPa to 5 MPa; 2 MPa to 5 MPa; 3 MPa to 5 MPa; or 4 MPa to 5 MPa. In various implementations, the second reactor of the nitrogen separation system may be operated at a pressure of no less than 0.01 MPa; no less than 0.05 MPa; no less than 0.07 MPa; no less than 0.09 MPa; no less than 0.3 MPa; no less than 0.5 MPa; no less than 0.7 MPa; no less than 0.9 MPa; no less than 1 MPa; or no less than 3 MPa. In various implementations, the second reactor of the nitrogen separation system may be operated at a pressure of no greater than 5 MPa; no greater than 4 MPa; no greater than 2 MPa; no greater than 1 MPa; no greater than 0.8 MPa; no greater than 0.6 MPa; no greater than 0.4 MPa; no greater than 0.2 MPa; no greater than 0.08 MPa; no greater than 0.06; no greater than 0.04; or no greater than 0.02 MPa.

In various implementations, the nitrogen separation system may contribute, relative to a total amount of nitrogen gas (N₂) provided to the sulfidation and regeneration system, between about 0 vol. % to about 25 vol. %; about 1 vol. % to about 25 vol. %; 2 vol. % to about 25 vol. %; about 3 vol. % to about 25 vol. %; about 4 vol. % to about 25 vol. %; about 5 vol. % to about 25 vol. %; about 6 vol. % to about 25 vol. %; about 7 vol. % to about 25 vol. %; about 8 vol. % to about 25 vol. %; about 9 vol. % to about 25 vol. %; about 10 vol. % to about 25 vol. %; about 15 vol. % to about 25 vol. %; about 20 vol. % to about 25 vol. %; about 21 vol. % to about 25 vol. %; about 22 vol. % to about 25 vol. %; about 23 vol. % to about 25 vol. %; about 24 vol. % to about 25 vol. %. In various implementations, the nitrogen separation system may contribute, relative to a total amount of nitrogen gas (N₂) provided to the sulfidation and regeneration system, no less than 1 vol. %; no less than 5 vol. %; no less than 10 vol. %; no less than 15 vol. %; or no less than 20 vol. %. In various implementations, the nitrogen separation system may contribute, relative to a total amount of nitrogen gas (N₂) provided to the sulfidation and regeneration system, no greater than 25 vol. %; no greater than 22 vol. %; no greater than 18 vol. %; no greater than 12 vol. %; no greater than 8 vol. %; or no greater than 2 vol. %.

Nitrogen gas (N₂) and sulfur gas (S) is provided from the sulfidation and regeneration system to a sulfur condenser (operation 604). The sulfur condenser operates to separate the sulfur gas (S) from the nitrogen gas (N₂). The sulfur gas (S) is provided from a first outlet of the sulfur condenser. The second outlet of the sulfur condenser is in fluid communication with an inlet of the blower.

In various implementations, the sulfur condenser may be operated at temperature of about 100° C. to about 450° C.; about 110° C. to about 450° C.; about 120 to about 450° C.; about 130° C. to about 450° C.; about 140° C. to about 450° C.; about 150° C. to about 450° C.; about 160° C. to 450° C.; about 170° C. to about 450° C.; about 180° C. to about 450° C.; about 190° C. to about 450° C.; about 200° C. to about 450° C.; about 225° C. to about 450° C.; about 250° C. to about 450° C.; about 275° C. to about 450° C.; about 300° C. to about 450° C.; about 325° C. to about 450° C.; about 350° C. to about 450° C.; about 375° C. to about 450° C.; or about 400° C. to about 450° C. In various implementations, the sulfur condenser may be operated at a temperature of no less than 100° C.; no less than 150° C.; no less than 200° C.; no less than 250° C.; no less than 300° C.; no less than 350° C.; or no less than 400° C. In various implementations, the sulfur condenser may be operated at a temperature of no greater than 450° C.; no greater than 425° C.; no greater than 375° C.; no greater than 325° C.; no greater than 275° C.; no greater than 225° C.; no greater than 175° C.; or no greater than 125° C.

In various implementations, the sulfur condenser may be operated at a pressure between about 0.1 MPa to about 10 MPa; 0.2 MPa to 10 MPa; 0.3 MPa to 10 MPa; 0.4 MPa to 10 MPa; 0.5 MPa to 10 MPa; 0.6 MPa to 10 MPa; 0.7 MPa to 10 MPa; 0.8 MPa to 10 MPa; 0.9 MPa to 10 MPa; 1 MPa to 10 MPa; 1.5 MPa to 10 MPa; 2 MPa to 10 MPa; 2.5 MPa to 10 MPa; 3 MPa to 10 MPa; 3.5 MPa to 10 MPa; 4 MPa to 10 MPa; 4.5 MPa to 10 MPa; 5 MPa to 10 MPa; 5.5 MPa to 10 MPa; 6 MPa to 10 MPa; 6.5 MPa to 10 MPa; 7 MPa to 10 MPa; 7.5 MPa to 10 MPa; 8 MPa to 10 MPa; 8.5 MPa to 10 MPa; or 9 MPa to 10 MPa. In various implementations, the sulfur condenser may be operated at a pressure of no less than 0.1 MPa; no less than 0.5 MPa; no less than 0.7 MPa; no less than 0.9 MPa; no less than 3 MPa; no less than 5 MPa; no less than 7 MPa; or no less than 9 MPa. In various implementations, the sulfur condenser may be operated at a pressure of no greater than 10 MPa; no greater than 8 MPa; no greater than 6 MPa; no greater than 4 MPa; no greater than 2 MPa; no greater than 1 MPa; no greater than 0.8 MPa; no greater than 0.6 MPa; no greater than 0.4 MPa; no greater than 0.2 MPa.

Nitrogen gas (N₂) is provided to an inlet of the blower. The blower operates to increase the pressure of the nitrogen gas (N₂) stream.

The outlet of the blower may have a pressure between 0.01 MPa to 15 MPa.

The pressurized nitrogen gas (N₂) is provided from the blower to the sulfidation and regeneration system. The blower is in fluid communication with the sulfidation and regeneration system.

In various implementations, the blower may contribute, relative to a total amount of nitrogen gas (N₂) provided to the sulfidation and regeneration system, between about 75 vol. % to about 100 vol. %; about 75 vol. % to about 100 vol. %; about 80 vol. %; to about 100 vol. %; about 85 vol. % to about 100 vol. %; about 90 vol. %; to about 100 vol. %; about 95 vol. % to about 100 vol. %. In various implementations, the blower may contribute, relative to a total amount of nitrogen gas (N₂) provided to the sulfidation and regeneration system, no less than 75 vol. %; no less than 80 vol. %; no less than 85 vol. %; no less than 90 vol. %; or no less than 95 vol. %. In various implementations, the blower may contribute, relative to a total amount of nitrogen gas (N₂) provided to the sulfidation and regeneration system, no greater than about 100 vol. %; no greater than about 98 vol. %; no greater than 92 vol. %; no greater than 88 vol. %; no greater than 82 vol. %; or no greater than 78 vol. %.

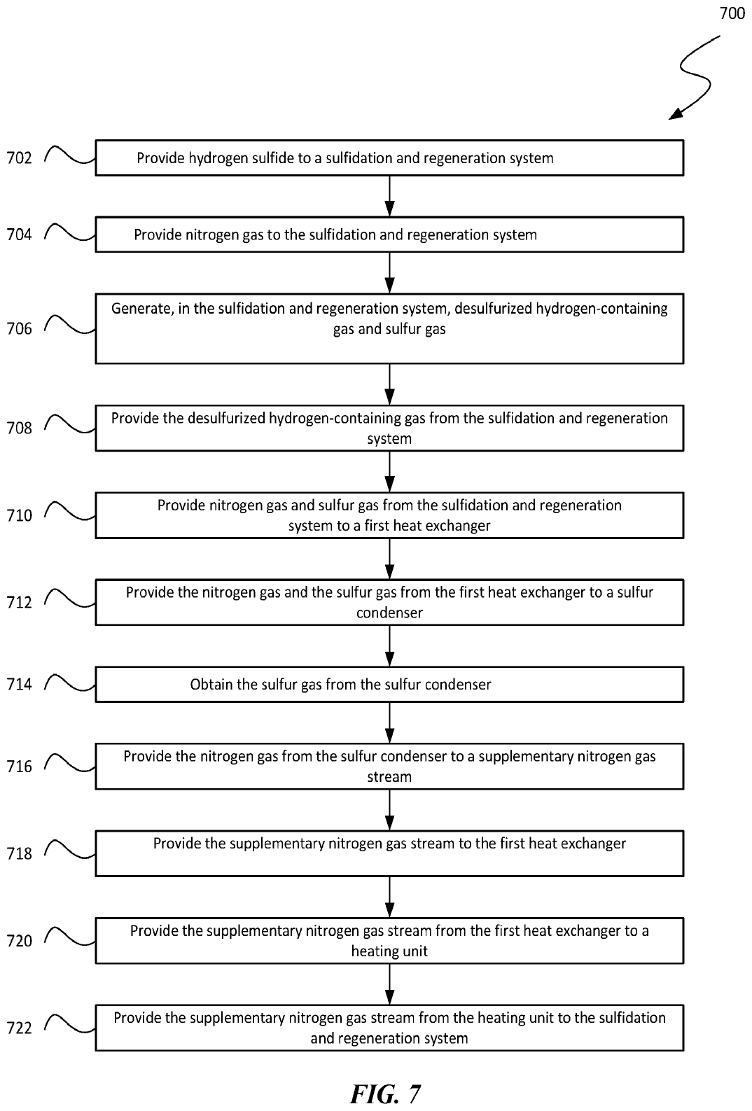

FIG. 7 shows example method 700 for operating a reactor system. As shown, method 700 includes providing hydrogen sulfide (H₂S) to a sulfidation and regeneration system (operation 702), providing nitrogen gas (N₂) to a sulfidation and regeneration system (operation 704), generating desulfurized hydrogen-containing gas and sulfur gas (S) by reacting the hydrogen sulfide containing gas with a plurality of metal sulfide particles (operation 706), providing the desulfurized hydrogen-containing gas from the sulfidation and regeneration system (operation 708), providing nitrogen gas (N₂) and sulfur gas (S) from the sulfidation and regeneration system to a first heat exchanger (operation 710), providing nitrogen gas (N₂) and sulfur gas (S) from the first heat exchanger to a sulfur condenser (operation 712), obtaining the sulfur gas from the sulfur condenser (operation 714), providing nitrogen gas (N₂) from the sulfur condenser to a supplementary nitrogen gas (N₂) stream (operation 716), providing the supplementary nitrogen gas (N₂) stream to the first heat exchanger (operation 718), providing the supplementary nitrogen gas (N₂) stream from the first heat exchanger to a heating unit (operation 720), and providing the supplementary gas (N₂) stream from the heating unit to the sulfidation and regeneration system (operation 722). Other embodiments may include more or fewer operations. Exemplary systems described and contemplated herein can be utilized to perform the operations of method 700. Unless otherwise indicated, and for the sake of brevity, some operations in FIG. 7 have the same or similar operation as those similarly numbered in method 600 shown in FIG. 6.

In various implementations, method 700 may begin by providing hydrogen sulfide (H₂S) to a first inlet of a sulfidation and regeneration system (operation 702). Nitrogen gas (N₂) is provided to a second inlet of the sulfidation and regeneration system (operation 704).

Method 700 also includes generating, in the sulfidation and regeneration system, desulfurized hydrogen-containing gas and sulfur gas by reacting the hydrogen sulfide (H₂S) with a plurality of sulfur lean metal sulfide particles (operation 706).

The desulfurized hydrogen-containing gas is provided from the sulfidation and regeneration system to a hot inlet of the second heat exchanger (operation 708).

The nitrogen gas (N₂) and sulfur gas (S) is provided to a first inlet of the first heat exchanger (operation 710). The first inlet of the first heat exchanger is in fluid communication with the second outlet of the sulfidation and regeneration system. The nitrogen gas (N₂) and sulfur gas (S) is provided from the cold outlet of the first heat exchanger.

In various implementations, the hot inlet stream of the first heat exchanger or the second heat exchanger may have a temperature between about 20° C. to about 1500° C.; about 150° C. to about 1500° C.; about 200 to about 1500° C.; about 250° C. to about 1500° C.; about 300° C. to about 1500° C.; about 350° C. to about 1500° C.; about 400° C. to 1500° C.; about 450° C. to about 1500° C.; about 500° C. to about 1500° C.; about 550° C. to about 1500° C.; about 600° C. to about 1500° C.; about 650° C. to about 1500° C.; about 700° C. to about 1500° C.; about 750° C. to about 1500° C.; about 800° C. to about 1500° C.; about 850° C. to about 1500° C.; about 900° C. to about 1500° C.; about 950° C. to about 1500° C.; about 1000° C. to about 1500° C.; about 1100° C. to about 1500° C.; about 1200° C. to about 1500° C.; about 1300° C. to about 1500° C.; or about 1400° C. to about 1500° C. In various implementations, the hot inlet stream of the first heat exchanger or the second heat exchanger may have a temperature of no less than 100° C.; no less than 150° C.; no less than 250° C.; no less than 350° C.; no less than 450° C.; no less than 550° C.; no less than 650° C.; no less than 750° C.; no less than 850° C.; no less than 950° C.; no less than 1050° C.; no less than 1150° C.; no less than 1250° C.; no less than 1350° C.; or no less than 1450° C. In various implementations, the hot inlet stream of the first heat exchanger or the second heat exchanger may have a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; no greater than 225° C.; no greater than 175° C.; or no greater than 125° C.

In various implementations, the cold inlet stream of the first heat exchanger or the second heat exchanger may have a temperature between about 50° C. to about 300° C.; about 75° C. to about 300° C.; about 100 to about 300° C.; about 125° C. to about 300° C.; about 150° C. to about 300° C.; about 175° C. to about 300° C.; about 200° C. to 300° C.; about 225° C. to about 300° C.; about 250° C. to about 300° C.; or about 275° C. to about 300° C. In various implementations, the cold inlet stream of the first heat exchanger may have a temperature of no less than 50° C.; no less than 100° C.; no less than 150° C.; no less than 200° C.; or no less than 250° C. In various implementations, the cold inlet stream of the first heat exchanger or the second heat exchanger may have a temperature of no greater than no greater than 300° C.; no greater than 275° C.; no greater than 225° C.; no greater than 175° C.; no greater than 125° C.; or no greater than 75° C.

In various implementations, an inlet of a low-pressure steam generator is configured to receive the nitrogen gas (N₂) and sulfur gas (S). The inlet of the low-pressure steam generator is in fluid communication with the cold outlet of the first heat exchanger.

In various implementations, the inlet stream of the low-pressure steam generator may have a temperature between 160° C. to about 250° C.; about 170° C. to about 250° C.; about 180° C. to about 250° C.; about 190 to about 250° C.; about 200° C. to about 250° C.; about 210° C. to about 250° C.; about 220° C. to about 250° C.; about 230° C. to 250° C.; or about 240° C. to about 250° C. In various implementations, the cold outlet stream of the low-pressure steam generator may have a temperature of no less than 160° C.; no less than 180° C.; no less than 200° C.; no less than 220° C.; or no less than 240° C. In various implementations, the cold outlet stream of the low-pressure steam generator may have a temperature of no greater than no greater than 250° C.; no greater than 230° C.; no greater than 210° C.; no greater than 190° C.; no greater than 170° C.

In various implementations, the outlet stream of the low-pressure steam generator may have a temperature between 160° C. to about 200° C.; about 170° C. to about 200° C.; about 180° C. to about 200° C.; or about 190 to about 200° C. In various implementations, the cold outlet stream of the low-pressure steam generator may have a temperature of no less than 160° C.; no less than 170° C.; no less than 180° C.; or no less than 190° C. In various implementations, the cold outlet stream of the low-pressure steam generator may have a temperature of no greater than no greater than 200° C.; no greater than 195° C.; no greater than 185° C.; no greater than 175° C.; or no greater than 165° C.

Method 700 may also include providing the nitrogen gas (N₂) and sulfur gas (S) from the first heat exchanger to a sulfur condenser (operation 712). The inlet of the sulfur condenser is in fluid communication with the cold outlet of the first heat exchanger.

In various implementations, the inlet of the sulfur condenser is in fluid communication with the outlet of the low-pressure steam generator.

In various implementations, the inlet stream of the sulfur condenser may be between about 300° C. to about 1500° C.; about 350° C. to about 1500° C.; about 400° C. to 1500° C.; about 450° C. to about 1500° C.; about 500° C. to about 1500° C.; about 550° C. to about 1500° C.; about 600° C. to about 1500° C.; about 650° C. to about 1500° C.; about 700° C. to about 1500° C.; about 750° C. to about 1500° C.; about 800° C. to about 1500° C.; about 850° C. to about 1500° C.; about 900° C. to about 1500° C.; about 950° C. to about 1500° C.; about 1000° C. to about 1500° C.; about 1100° C. to about 1500° C.; about 1200° C. to about 1500° C.; about 1300° C. to about 1500° C.; or about 1400° C. to about 1500° C. In various implementations, the inlet stream of the sulfur condenser may have a temperature of no less than 300° C.; no less than 350° C.; no less than 450° C.; no less than 550° C.; no less than 650° C.; no less than 750° C.; no less than 850° C.; no less than 950° C.; no less than 1050° C.; no less than 1150° C.; no less than 1250° C.; no less than 1350° C.; or no less than 1450° C. In various implementations, the inlet stream of the sulfur condenser may have a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 300° C.

In various implementations, the first and second outlet streams of the sulfur condenser may have a temperature between about 100° C. to about 130° C. In various implementations, the first and second outlet streams of the sulfur condenser may have a temperature of no less than 100° C. In various implementations, the first and second outlet streams of the sulfur condenser may have a temperature of no greater than no greater than 130° C.

Method 700 may also include obtaining sulfur gas from the first outlet of the sulfur condenser (operation 714).

In various implementations, the nitrogen gas (N₂) is provided from the sulfur condenser to a cooling unit. The second outlet of the sulfur condenser is in fluid communication with an inlet of the cooling unit. The outlet of the cooling unit is in fluid communication with a supplementary nitrogen gas (N₂) stream.

In various implementations, the inlet stream of the cooling unit may have a temperature between about 80° C. to about 120° C.; about 90° C. to about 120° C.; about 100 to about 120° C.; about 110° C. to about 120° C.; about 80° C. to about 110° C.; about 80° C. to about 100° C.; or about 80° C. to 90° C. In various implementations, the inlet stream of the cooling unit may have a temperature of no less than 80° C.; no less than 90° C.; no less than 100° C.; or no less than 110° C. In various implementations, the inlet stream of the cooling unit may have a temperature of no greater than no greater than 120° C.; no greater than 115° C.; no greater than 105° C.; no greater than 95° C.; or no greater than 85° C.

In various implementations, the outlet stream of the cooling unit may have a temperature between about 20° C. to about 80° C.; about 30° C. to about 80° C.; about 40 to about 80° C.; about 50° C. to about 80° C.; about 60° C. to about 80° C.; about 70° C. to about 80° C.; about 20° C. to 70° C.; about 20° C. to about 60° C.; about 20° C. to about 50° C.; about 20° C. to about 40° C.; or about 20° C. to about 30° C. In various implementations, the outlet stream of the cooling unit may have a temperature of no less than 20° C.; no less than 30° C.; no less than 40° C.; no less than 50° C.; no less than 60° C.; or no less than 70° C. In various implementations, the outlet stream of the cooling unit may have a temperature of no greater than no greater than 80° C.; no greater than 75° C.; no greater than 65° C.; no greater than 55° C.; no greater than 45° C.; no greater than 35° C.; or no greater than 25° C.

The nitrogen gas (N₂) is provided from the sulfur condenser to a supplementary nitrogen gas (N₂) stream (operation 716).

In various implementations, the supplementary nitrogen gas (N₂) stream is provided to a blower. The blower is configured to provide the supplementary nitrogen gas (N₂) from an outlet. The outlet of the blower is in fluid communication with the cold inlet of the first heat exchanger.

In various implementations, the inlet stream of the blower may have a pressure between about 0.01 MPa to about 0.5 MPa; 0.02 MPa to 0.5 MPa; 0.03 MPa to 0.5 MPa; 0.04 MPa to 0.5 MPa; 0.05 MPa to 0.5 MPa; 0.06 MPa to 0.5 MPa; 0.07 MPa to 0.5 MPa; 0.08 MPa to 0.5 MPa; 0.09 MPa to 0.5 MPa; 0.1 MPa to 0.5 MPa; 0.15 MPa to 0.5 MPa; 0.2 MPa to 0.5 MPa; 0.25 MPa to 0.5 MPa; 0.3 MPa to 0.5 MPa; 0.35 MPa to 0.5 MPa; 0.4 MPa to 0.5 MPa; or 0.45 MPa to 0.5 MPa. In various implementations, the inlet stream of the blower may have a pressure of no less than 0.01 MPa; no less than 0.05 MPa; no less than 0.1 MPa; no less than 0.15 MPa; no less than 0.2 MPa; no less than 0.25 MPa; no less than 0.3 MPa; no less than 0.35 MPa; no less than 0.4 MPa; or no less than 0.45 MPa. In various implementations, the inlet stream of the blower may have a pressure of no greater than 0.5 MPa; no greater than 0.47 Pa; no greater than 0.42 MPa; no greater than 0.37 MPa; no greater than 0.32 MPa; no greater than 0.27 MPa; no greater than 0.22 MPa; no greater than 0.17 MPa; no greater than 0.12 MPa; or no greater than 0.05 MPa.

In various implementations, the outlet stream of the blower may have a pressure between about 0.1 MPa to about 15 MPa; about 1 MPa to about 150 MPa; about 10 MPa to about 150 MPa; about 25 MPa to about 150 MPa; about 50 MPa to about 150 MPa; about 75 MPa to about 150 MPa; about 100 MPa to about 150 MPa; about 110 MPa to about 150 MPa; or about 125 MPa to about 150 MPa. In various implementations, the outlet stream of the blower may have a pressure of no less than 0.1 MPa; no less than 1 MPa; no less than 10 MPa; no less than 25 MPa; no less than 75 MPa; or no less than 125 MPa. In various implementations, the outlet stream of the blower may have a pressure of no greater than 150 MPa; no greater than 135 MPa; no greater than 115 MPa; no greater than 100 MPa; no greater than 85 MPa; no greater than 50 MPa; no greater than 20 MPa; no greater than 5 MPa; no greater than 2 MPa; or no greater than 0.5 MPa.

The supplementary nitrogen gas (N₂) stream is provided to the first heat exchanger (operation 718). The first heat exchanger may operate as described above.

The supplementary nitrogen gas (N₂) stream is provided from the first heat exchanger to a heating unit (operation 720).

After heating, the supplementary nitrogen gas (N₂) stream is provided to the sulfidation and regeneration system (operation 722). The outlet of the heating unit is in fluid communication with the second inlet of the sulfidation and regeneration system.

In various implementations, the heating unit may operate at a temperature between about 50° C. to about 1500° C.; about 100° C. to about 1500° C.; about 200 to about 1500° C.; about 300° C. to about 1500° C.; about 400° C. to about 1500° C.; about 500° C. to about 1500° C.; about 600° C. to about 1500° C.; about 700° C. to about 1500° C.; about 800° C. to about 1500° C.; about 900° C. to about 1500° C.; about 1000° C. to about 1500° C.; about 1100° C. to about 1500° C.; about 1200° C. to about 1300° C.; or about 1400° C. to about 1500° C. In various implementations, the heating unit may operate at a temperature of no less than 100° C.; no less than 300° C.; no less than 500° C.; no less than 700° C.; no less than 900° C.; no less than 1100° C.; or no less than 1300° C. In various implementations, the heating unit may operate at a temperature of no greater than 1500° C.; no greater than 1400° C.; no greater than 1200° C.; no greater than 1000° C.; no greater than 800° C.; no greater than 600° C.; no greater than 400° C.; or no greater than 200° C.

In various implementations, the cold outlet of the second heat exchanger is in fluid communication with the inlet of the PSAU.

In various implementations, the PSAU may operate at a temperature between about 30° C. to about 100° C.

In various implementations, high-pressure steam is provided to an inlet of a steam turbine. A third outlet of the sulfidation and regeneration system is in fluid communication with the inlet of the steam turbine.

In various implementations, the inlet and outlet streams of the steam turbine may have a temperature between about 120° C. to about 700° C.; about 150° C. to about 700° C.; about 200 to about 700° C.; about 250° C. to about 700° C.; about 300° C. to about 700° C.; about 350° C. to about 700° C.; about 400° C. to about 700° C.; about 450° C. to about 700° C.; about 500° C. to about 700° C.; about 550° C. to about 700° C.; about 600° C. to about 700° C. In various implementations, the inlet stream of the steam turbine may have a temperature of no less than 120° C.; no less than 150° C.; no less than 200° C.; no less than 250° C.; no less than 300° C.; no less than 350° C.; no less than 400° C.; no less than 450° C.; no less than 500° C.; no less than 550° C.; or no less than 600° C. In various implementations, the inlet of the steam turbine may have a temperature of no greater than 700° C.; no greater than 650° C.; no greater than 575° C.; no greater than 525° C.; no greater than 475° C.; no greater than 425° C.; no greater than 375° C.; no greater than 325° C.; no greater than 275° C.; no greater than 225° C.; or no greater than 175° C.

In various implementations the inlet and outlet streams of the steam turbine may have a pressure between about 0.1 MPa to about 6 MPa; about 1 MPa to about 6 MPa; about 2 MPa to about 6 MPa; about 3 MPa to about 6 MPa; about 4 MPa to about 6 MPa; about 5 MPa to about 6 MPa. In various implementations, the inlet and outlet streams of the steam turbine may have a pressure of no less than 0.1 MPa; no less than 0.5 MPa; no less than 1 MPa; no less than 1.5 MPa; no less than 2 MPa; no less than 2.5 MPa; no less than 3 MPa; no less than 3.5 MPa; no less than 4 MPa; no less than 4.5 MPa; no less than 5 MPa; or no less than 5.5 MPa. In various implementations, the inlet and outlet streams of the steam turbine may have a pressure of no greater than 6 MPa; no greater than 5.75 MPa; no greater than 5.25 MPa; no greater than 4.75 MPa; no greater than 4.25 MPa; no greater than 3.75 MPa; no greater than 3.25 MPa; no greater than 2.75 MPa; no greater than 2.25 MPa; no greater than 1.75 MPa; no greater than 1.25 MPa; no greater than 0.75 MPa; or no greater than 0.25 MPa.

In various implementations, the ASU may operate at a temperature between about −100° C. to about −250° C. In various implementations, the ASU may operate at a pressure between 0.5 MPa to 30 MPa.

### V. Computational and Experimental Data

Acid gases from various sources, including but not limited to syngas production, mineral processing, and crude fossil fuel processing, can have moisture content. The solid material used in the sulfidation regeneration reactor is capable of handling moisture present in the acid gas in the concentration range of 0% to 10%. To check the conversion of hydrogen sulfide (H₂S) and water (H₂O) and/or the formation of multiferroic spinel (FeCr₂S₄) and chromium(III) oxide (Cr₂O₃), thermodynamic studies were conducted at 400° C. using the Equilib module of FactSage™ 8.1 software.

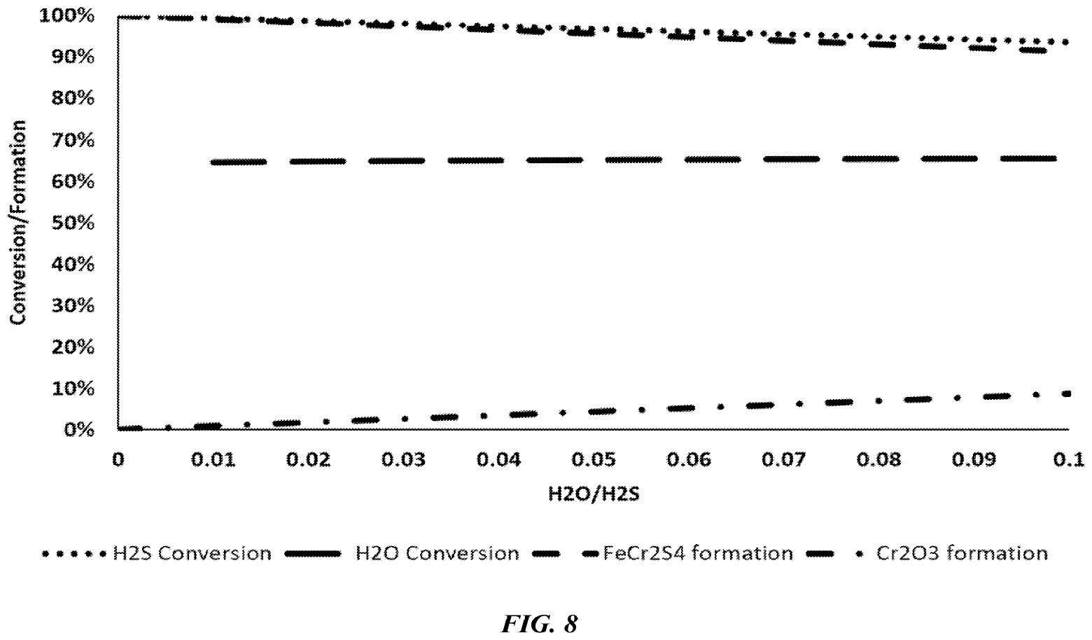

For a base case, Fe, Cr, and H₂S were input in stoichiometric amounts according to equation (1), shown below. Then, the quantity of H₂O in the feed was gradually increased by varying the ratio between H₂O to H₂S from 0.01 to 0.1. H₂S conversion, H₂O conversion, FeCr₂S₄ formation, and Cr₂O₃ formation were plotted against H₂O/H₂S ratio as shown in FIG. 8.

As was observed from the graph shown in FIG. 8, at a ratio of H₂O/H₂S of 0.1, the H₂S conversion and FeCr₂S₄ formation remain about 90%. As was observed, the amount of Cr₂O₃ formation happening, which is expected to accumulate over numerous cycles. However, the material can then be reactivated using material reactivation from a nitrogen separation system.

$${FeCr}_{2} + 4 {H}_{2} S \to {FeCr}_{2} {S}_{4} + 4 {H}_{2} \qquad ( 1 )$$

Acid gases from various sources, including but not limited to syngas production, mineral processing, and crude fossil fuel processing, can have carbonyl sulfide (COS) content. The solid material used in the sulfidation and regeneration reactor is capable of handling COS present in the acid gas feed in the concentration range of o to 10%. Typically, in an acid gas stream, the amount of COS present is 0.09%.

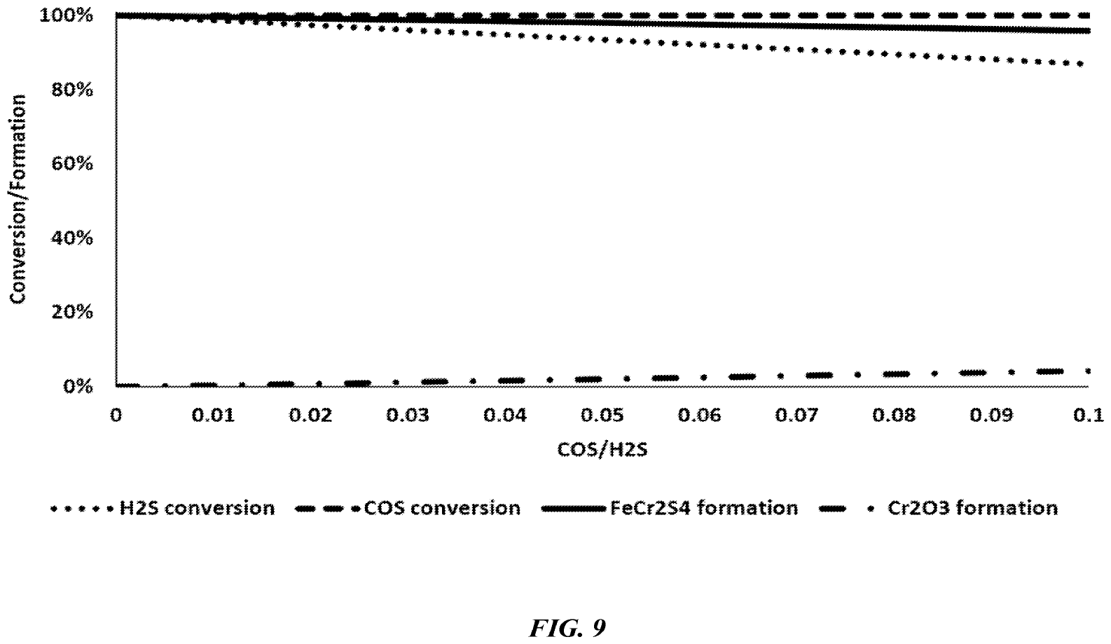

To check the conversion of hydrogen sulfide (H₂S) and carbonyl sulfide (COS) and/or the formation of multiferroic spinel (FeCr₂S₄) and chromium(III) oxide (Cr₂O₃), thermodynamic studies for the effect of COS with H₂S in the feed were conducted at 400° C. using the Equilib module of FactSage™ 8.1 software. For the base case, Fe, Cr, and H₂S were input in stoichiometric amounts according to equation (1), as shown above. Then, the quantity of COS in the feed was gradually increased by varying the ratio between COS to H₂S from 0.01 to 0.1. H₂S conversion, COS conversion, FeCr₂S₄ formation, and Cr₂O₃ formation was plotted against COS/H₂S ratio, as shown in FIG. 9.

As was observed from the graph shown in FIG. 9, at a ratio of COS/H₂S of 0.1, the COS conversion and FeCr₂S₄ formation remain above 80%. The amount of Cr₂O₃ formation occurring, which is expected to accumulate over numerous cycles. However, the material can then be reactivated using material reactivation of a nitrogen separation system.

Acid or sour gas from various industrial sources, including but not limited to syngas production, mineral processing, and crude fossil fuel processing, can contain ammonia (NH₃) along with H₂S. The solid material used in the sulfidation step acts as a catalyst for NH₃ decomposition into N₂ and H₂ without any formation of impurity phases such as nitrides of respective metals. In the example, thermodynamic and kinetic study were performed to understand the interaction between H₂S, NH₃, and solid material.

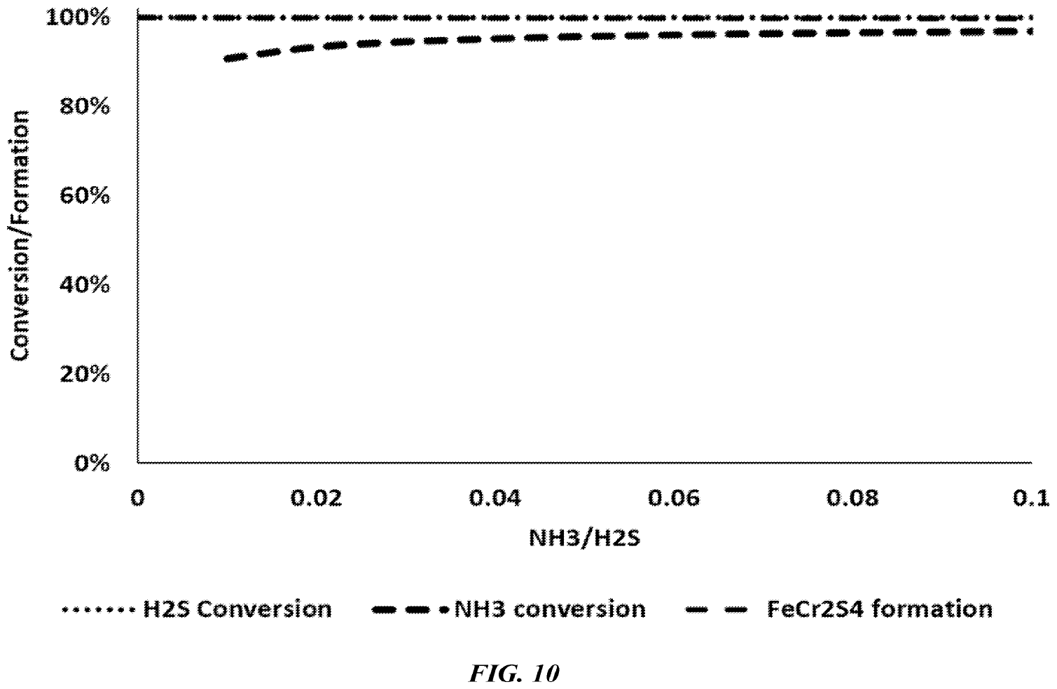

To check the conversion of hydrogen sulfide (H₂S) and ammonia (NH₃) and/or the formation of multiferroic spinel (FeCr₂S₄), thermodynamic studies to analyze the effect of NH₃ with H₂S in the feed were conducted at a sulfidation temperature of 400° C. using the Equilib module of FactSage™ 8.1 software. For the base case, Fe, Cr, and H₂S were input in stoichiometric amounts according to equation (1), as shown above. Then, the quantity of NH₃ in the feed was gradually increased by varying the ratio between NH₃ to H₂S from 0.01 to 0.1. H₂S conversion, NH₃ conversion, and FeCr₂S₄ formation were plotted against NH₃/H₂S ratio, as shown in FIG. 10.

As was observed from the graph shown in FIG. 10, at 400° C., NH₃ is fully decomposed into N₂ and H₂ without affecting the H₂S conversion or the FeCr₂S₄ formation.

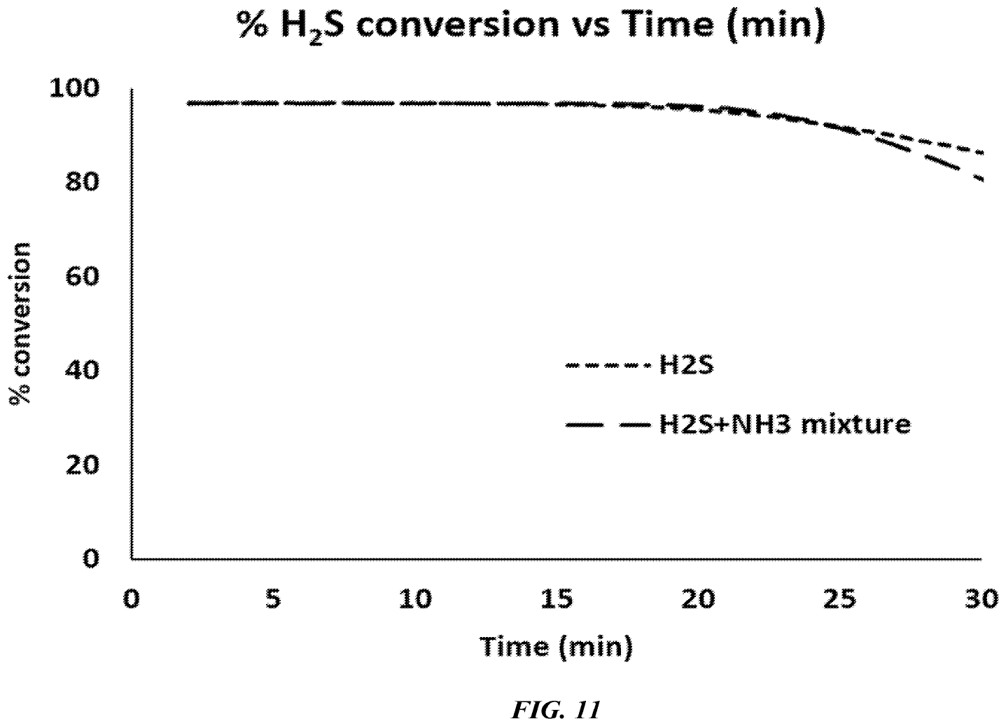

FIG. 11 shows the performance of an iron-chromium alloy in a fixed bed reactor for H₂S conversion to H₂ with and without the presence of NH₃ in the feed. The temperature of the sulfidation step was 700° C. In the first run, 0.9% H₂S balanced with N₂ gas was injected into the fixed bed reactor during the sulfidation step at the gas hourly space velocity (GHSV) at 7000 hr⁻¹. As was observed, the concentration of gas leaving the fixed bed reactor was measured using an Interscan® Model RM17-500m Toxic gas monitor to measure H₂S concentration in the reactor and calculate the H₂S conversion. The gas was also intermittently sampled by the Siemens® CALOMET 6E H₂ analyzer outlet to confirm the H₂ conversion. In the second run, 0.87% H₂S and 3.45% NH₃ balanced with N₂ were injected at the same temperature and GHSV in the fixed bed reactor.

As was observed from the graph shown in FIG. 11, the H₂S conversion calculated using the concentration data collected using the H₂S analyzer indicates that H₂S conversion remains unchanged in the presence of NH₃ in the feed. Moreover, the H₂ conversion calculated from the concentration from the concentration data collected using the H₂ analyzer indicates the complete conversion of NH₃ into H₂ and N₂. The solid phase analysis performed using X-Ray diffraction on the solids at the end of sulfidation shows the formation of iron sulfide, chromium sulfide and FeCr₂S₄. No nitride phases were detected.

For reasons of completeness, the following Embodiments are provided.

Embodiment 1. A method for operating a reactor system, the method comprising:
providing hydrogen sulfide (H₂S) and nitrogen gas (N₂) to a sulfidation and regeneration system;
providing nitrogen gas (N₂) and sulfur gas (S) from a first outlet of the sulfidation and regeneration system to an inlet of a sulfur condenser;
providing hydrogen gas (H₂) and waste gas from a second outlet of the sulfidation and regeneration system to an inlet of a hydrogen separation unit;
separating, in the hydrogen separation unit, a hydrogen gas (H₂) product from waste gas; providing a first output from the hydrogen separation unit to a first inlet of a nitrogen separation system, the first output comprising either the hydrogen gas (H₂) product or the waste gas;
providing an oxygen-source input stream to a second inlet of the nitrogen separation system, the oxygen-source input stream comprising nitrogen (N₂) and oxygen (O₂);
generating, in the nitrogen separation system, a plurality of oxidized oxygen carriers by contacting oxygen (O₂) with a plurality of reduced oxygen carriers;
providing nitrogen (N₂) from a first outlet of the nitrogen separation system to the sulfidation and regeneration system;
generating, in the nitrogen separation system, oxygen-comprising material and the plurality of reduced oxygen carriers by reacting the first output from the hydrogen separation unit with the plurality of oxidized oxygen carriers; and
providing the oxygen-comprising material from a second outlet of the nitrogen separation system.

Embodiment 2. The method according to Embodiment 1, the method further comprising:
providing sulfur gas (S) from a first outlet of the sulfur condenser;
providing nitrogen gas (N₂) from a second outlet of the sulfur condenser to an inlet of a blower; and
providing pressurized nitrogen gas (N₂) from an outlet of the blower to the sulfidation and regeneration system.

Embodiment 3. The method according to Embodiment 1 or Embodiment 2, the method further comprising:
providing, in the nitrogen separation system, the plurality of oxidized oxygen carriers from a first reactor to a second reactor; and
providing, in the nitrogen separation system, the plurality of reduced oxygen carriers from the second reactor to the first reactor.

Embodiment 4. The method according to Embodiment 3, the method further comprising:
operating the first reactor at a temperature between 100° C. and 1200° C. and at a pressure between 0.01 MPa to 5 MPa; and
operating the second reactor at a temperature between 100° C. and 1200° C. and at a pressure between 0.01 MPa to 5 MPa,
wherein a residence time of the second reactor and first reactor is between 0.5 seconds and 30 minutes.

Embodiment 5. The method according to any one of Embodiments 1-4, wherein between 0 volume percent (vol. %) and 25 volume percent (vol. %) of the nitrogen gas (N₂) provided to the sulfidation and regeneration system is from the nitrogen separation system.

Embodiment 6. The method according to any one of Embodiments 1-5, wherein the first output provided to the nitrogen separation system comprises the hydrogen gas (H₂) product, and
wherein between 1 volume percent (vol. %) and 80 vol. % of the hydrogen gas (H₂) product generated by the hydrogen separation unit is provided to the nitrogen separation system.

Embodiment 7. The method according to any one of Embodiments 1-6, wherein the first output provided to the nitrogen separation system comprises waste gas; and
wherein the oxidized oxygen carriers and the reduced oxygen carriers comprise Ni, Co, Mn, oxides thereof, or combinations thereof.

Embodiment 8. The method according to any one of Embodiments 1-7, wherein the oxygen-comprising input stream provided to the nitrogen separation system comprises between 0 vol. % and 25 vol. % nitrogen gas (N₂).

Embodiment 9. A reactor system, comprising:
a sulfidation and regeneration system comprising:
   a first inlet in fluid communication with a hydrogen sulfide (H₂S) stream;
   a second inlet in fluid communication with a nitrogen gas (N₂) stream;
   a first outlet configured to provide a stream comprising nitrogen gas (N₂) and sulfur gas (S); and
   a second outlet in fluid communication with a hydrogen separation unit;
the hydrogen separation unit comprising:
   an inlet in fluid communication with the second outlet of the sulfidation and regeneration system;
   a first outlet configured to provide a hydrogen gas product stream; and
   a second outlet configured to provide a waste gas stream; and
a nitrogen separation system comprising:
   a first inlet in fluid communication with a slip stream from either the hydrogen gas product stream or the waste gas stream;
   a second inlet in fluid communication with an oxygen-source input stream, the oxygen-source input stream comprising nitrogen (N₂) and oxygen (O₂);
   a first outlet in fluid communication with the second inlet of the sulfidation and regeneration system; and
   a second outlet configured to provide oxygen-comprising material.

Embodiment 10. The reactor system according to Embodiment 9, the nitrogen separation system further comprising:
a second reactor comprising: a first inlet in fluid communication with the slip stream from either the hydrogen gas product stream or the waste gas stream;
a second inlet configured to receive a plurality of oxidized oxygen carriers;
a first outlet configured to provide the oxygen-comprising material; and
a second outlet configured to provide a plurality of reduced oxygen carriers; and a first reactor comprising:
a first inlet in fluid communication with the oxygen-source input stream;
a second inlet in fluid communication with the second outlet of the second reactor;
a first outlet in fluid communication with the second inlet of the sulfidation and regeneration system; and
a second outlet in fluid communication with the second inlet of the second reactor.

Embodiment 11. The reactor system according to Embodiment 10, further comprising:
the second reactor being configured as a fixed bed reactor, a fluidized bed reactor, a co-current moving bed reactor, or a counter-current moving bed reactor; and
the first reactor being configured as a fixed bed reactor, a fluidized bed reactor, a co-current moving bed reactor, or a counter-current moving bed reactor.

Embodiment 12. The reactor system according to any one of Embodiments 9-11, further comprising:
a sulfur condenser comprising:
   an inlet in fluid communication with the first outlet of the sulfidation and regeneration system;
   a first outlet of the sulfur condenser configured to provide sulfur gas (S); and
   a second outlet configured to provide nitrogen gas (N₂); and
a blower comprising:
   an inlet in fluid communication with the second outlet of the sulfur condenser; and
   an outlet in fluid communication with the second outlet of the sulfidation and regeneration system.

Embodiment 13. The reactor system according to any one of Embodiments 9-12, further comprising:
the first inlet of the nitrogen separation system in fluid communication with the slip stream comprising hydrogen gas product stream.

Embodiment 14. The reactor system according to any one of Embodiments 9-13, further comprising:
the first inlet of the nitrogen separation system in fluid communication with the slip stream comprising the waste gas stream.

Embodiment 15. A reactor system, comprising:
a sulfidation and regeneration system comprising:
   a first inlet in fluid communication with a hydrogen sulfide (H₂S) stream;
   a second inlet in fluid communication with a nitrogen gas (N₂) input stream;
   a first outlet configured to provide a nitrogen gas (N₂) and sulfur gas (S) stream; and
   a second outlet configured to provide a desulfurized hydrogen gas-containing stream; and
a first heat exchanger comprising:
   a first inlet in fluid communication with the first outlet of the sulfidation and regeneration system;
   a second inlet in fluid communication with the nitrogen gas (N₂) input stream;
   a first outlet in fluid communication with a first inlet of a heating unit; and
   a second outlet configured to provide a cooled nitrogen gas (N₂) and sulfur gas (S) stream;
a sulfur condenser comprising:
   an inlet in fluid communication with the cooled nitrogen gas (N₂) and sulfur gas (S) stream;
   a first outlet of the sulfur condenser configured to provide a sulfur gas (S) stream; and
   a second outlet of the sulfur condenser configured to provide a separated nitrogen gas (N₂) stream, the separated nitrogen gas (N₂) stream in fluid communication with an inlet of the nitrogen gas (N₂) input stream; and
the heating unit comprising:
   the first inlet in fluid communication with the first outlet of the first heat exchanger;
   a second inlet in fluid communication with a natural gas stream; and
   an outlet in fluid communication with the second inlet of the sulfidation and regeneration system.

Embodiment 16. The reactor system according to Embodiment 15, further comprising:
a second heat exchanger comprising:
   a cold inlet configured to receive a hydrogen sulfide (H₂S) stream;
   a hot inlet in fluid communication with the second outlet of the sulfidation and regeneration system;
   a cold outlet in fluid communication with an inlet of a pressure swing adsorption unit (PSAU); and
   a hot outlet in fluid communication with the first inlet of the sulfidation and regeneration system;
an air separation unit comprising:
   an inlet configured to receive an air stream; and
   an outlet in fluid communication with the nitrogen gas (N₂) input stream; and
a steam turbine comprising:
   an inlet in fluid communication with a third inlet of the sulfidation and regeneration system, the third inlet of the sulfidation and regeneration system configured to provide high-pressure steam; and
   an outlet configured to provide steam.

Embodiment 17. The reactor system according to Embodiment 15 or Embodiment 16, further comprising:
a cooling unit comprising:
   an inlet in fluid communication with the second inlet of the sulfur condenser; and
   an outlet in fluid communication with the nitrogen gas (N₂) input stream.

Embodiment 18. The reactor system according to any one of Embodiments 15-17, further comprising:
a low-pressure stream generator comprising:
   an inlet in fluid communication with the second outlet of the first heat exchanger; and
   an outlet in fluid communication with the inlet of the sulfur condenser.

Embodiment 19. The reactor system according to any one of Embodiments 15-18, further comprising:
a blower comprising:
   an inlet in fluid communication with the nitrogen gas (N₂) input stream; and
   an outlet in fluid communication with the second inlet of the first heat exchanger.

Embodiment 20. A method for operating a reactor system, the method comprising:
providing hydrogen sulfide (H₂S) gas to a first inlet of a sulfidation and regeneration system;
providing nitrogen gas (N₂) to a second inlet of the sulfidation and regeneration system;
generating, in the sulfidation and regeneration system, desulfurized hydrogen-containing gas and sulfur gas (S) by reacting the hydrogen sulfide (H₂S) gas with a plurality of metal sulfide particles;
providing the desulfurized hydrogen-containing gas from a first outlet of the sulfidation and regeneration system;
providing nitrogen gas (N₂) and the sulfur gas (S) from a second outlet of the sulfidation and regeneration system to a first inlet of a first heat exchanger;
providing the nitrogen gas (N₂) and the sulfur gas (S) from a first outlet of the first heat exchanger to an inlet of a sulfur condenser;
obtaining the sulfur gas (S) from a first outlet of the sulfur condenser;
providing the nitrogen gas (N₂) from a second outlet of the sulfur condenser to an inlet of a supplementary nitrogen gas (N₂) stream;
providing the supplementary nitrogen gas (N₂) stream to the second inlet of the first heat exchanger; and
providing the supplementary nitrogen gas (N₂) stream from a second outlet of the first heat exchanger to an inlet of a heating unit; and
providing the supplementary nitrogen gas (N₂) stream from an outlet of the heating unit to the second inlet of the sulfidation and regeneration system.

What is claimed is:

1. A method for operating a reactor system, the method comprising:
providing hydrogen sulfide (H₂S) and nitrogen gas (N₂) to a sulfidation and regeneration system;
providing nitrogen gas (N₂) and sulfur gas (S) from a first outlet of the sulfidation and regeneration system to an inlet of a sulfur condenser;
providing hydrogen gas (H₂) and waste gas from a second outlet of the sulfidation and regeneration system to an inlet of a hydrogen separation unit;
separating, in the hydrogen separation unit, a hydrogen gas (H₂) product from waste gas;
providing a first output from the hydrogen separation unit to a first inlet of a nitrogen separation system, the first output comprising either the hydrogen gas (H₂) product or the waste gas;
providing an oxygen-source input stream to a second inlet of the nitrogen separation system, the oxygen-source input stream comprising nitrogen (N₂) and oxygen (O₂);
generating, in the nitrogen separation system, a plurality of oxidized oxygen carriers by contacting oxygen (O₂) with a plurality of reduced oxygen carriers;
providing nitrogen (N₂) from a first outlet of the nitrogen separation system to the sulfidation and regeneration system;
generating, in the nitrogen separation system, oxygen-comprising material and the plurality of reduced oxygen carriers by reacting the first output from the hydrogen separation unit with the plurality of oxidized oxygen carriers; and
providing the oxygen-comprising material from a second outlet of the nitrogen separation system.

2. The method according to claim 1, the method further comprising:
providing sulfur gas (S) from a first outlet of the sulfur condenser;
providing nitrogen gas (N₂) from a second outlet of the sulfur condenser to an inlet of a blower; and
providing pressurized nitrogen gas (N₂) from an outlet of the blower to the sulfidation and regeneration system.

3. The method according to claim 2, the method further comprising:
providing, in the nitrogen separation system, the plurality of oxidized oxygen carriers from a first reactor to a second reactor; and
providing, in the nitrogen separation system, the plurality of reduced oxygen carriers from the second reactor to the first reactor.

4. The method according to claim 3, the method further comprising:
operating the first reactor at a temperature between 100° C. and 1200° C. and at a pressure between 0.01 MPa to 5 MPa; and
operating the second reactor at a temperature between 100° C. and 1200° C. and at a pressure between 0.01 MPa to 5 MPa,
wherein a residence time of the second reactor and first reactor is between 0.5 seconds and 30 minutes.

5. The method according to claim 1, wherein between 0 volume percent (vol. %) and 25 volume percent (vol. %) of the nitrogen gas (N₂) provided to the sulfidation and regeneration system is from the nitrogen separation system.

6. The method according to claim 1, wherein the first output provided to the nitrogen separation system comprises the hydrogen gas (H₂) product, and
wherein between 1 volume percent (vol. %) and 80 vol. % of the hydrogen gas (H₂) product generated by the hydrogen separation unit is provided to the nitrogen separation system.

7. The method according to claim 1, wherein the first output provided to the nitrogen separation system comprises waste gas; and
wherein the oxidized oxygen carriers and the reduced oxygen carriers comprise Ni, Co, Mn, oxides thereof, or combinations thereof.

8. The method according to claim 1, wherein the oxygen-comprising input stream provided to the nitrogen separation system comprises between 0 vol. % and 25 vol. % nitrogen gas (N₂).

9. A reactor system, comprising:
a sulfidation and regeneration system comprising:
a first inlet in fluid communication with a hydrogen sulfide (H₂S) stream;
a second inlet in fluid communication with a nitrogen gas (N₂) stream;
a first outlet configured to provide a stream comprising nitrogen gas (N₂) and sulfur gas (S); and
a second outlet in fluid communication with a hydrogen separation unit;
the hydrogen separation unit comprising:
an inlet in fluid communication with the second outlet of the sulfidation and regeneration system;
a first outlet configured to provide a hydrogen gas product stream; and
a second outlet configured to provide a waste gas stream; and
a nitrogen separation system comprising:
a first inlet in fluid communication with a slip stream from either the hydrogen gas product stream or the waste gas stream;
a second inlet in fluid communication with an oxygen-source input stream, the oxygen-source input stream comprising nitrogen (N₂) and oxygen (O₂);
a first outlet in fluid communication with the second inlet of the sulfidation and regeneration system; and
a second outlet configured to provide oxygen-comprising material.

10. The reactor system according to claim 9, the nitrogen separation system further comprising:
a second reactor comprising: a first inlet in fluid communication with the slip stream from either the hydrogen gas product stream or the waste gas stream;
a second inlet configured to receive a plurality of oxidized oxygen carriers;
a first outlet configured to provide the oxygen-comprising material; and
a second outlet configured to provide a plurality of reduced oxygen carriers; and
a first reactor comprising:
a first inlet in fluid communication with the oxygen-source input stream;
a second inlet in fluid communication with the second outlet of the second reactor;
a first outlet in fluid communication with the second inlet of the sulfidation and regeneration system; and
a second outlet in fluid communication with the second inlet of the second reactor.

11. The reactor system according to claim 10, further comprising:
the second reactor being configured as a fixed bed reactor, a fluidized bed reactor, a co-current moving bed reactor, or a counter-current moving bed reactor; and
the first reactor being configured as a fixed bed reactor, a fluidized bed reactor, a co-current moving bed reactor, or a counter-current moving bed reactor.

12. The reactor system according to claim 9, further comprising:
a sulfur condenser comprising:
an inlet in fluid communication with the first outlet of the sulfidation and regeneration system;
a first outlet of the sulfur condenser configured to provide sulfur gas (S); and
a second outlet configured to provide nitrogen gas (N₂); and
a blower comprising:
an inlet in fluid communication with the second outlet of the sulfur condenser; and
an outlet in fluid communication with the second outlet of the sulfidation and regeneration system.

13. The reactor system according to claim 9, further comprising:
the first inlet of the nitrogen separation system in fluid communication with the slip stream comprising hydrogen gas product stream.

14. The reactor system according to claim 9, further comprising:
the first inlet of the nitrogen separation system in fluid communication with the slip stream comprising the waste gas stream.

15. A reactor system, comprising:
a sulfidation and regeneration system comprising:
a first inlet in fluid communication with a hydrogen sulfide (H₂S) stream;
a second inlet in fluid communication with a nitrogen gas (N₂) input stream;
a first outlet configured to provide a nitrogen gas (N₂) and sulfur gas (S) stream; and
a second outlet configured to provide a desulfurized hydrogen gas-containing stream; and
a first heat exchanger comprising:
a first inlet in fluid communication with the first outlet of the sulfidation and regeneration system;
a second inlet in fluid communication with the nitrogen gas (N₂) input stream;
a first outlet in fluid communication with a first inlet of a heating unit; and
a second outlet configured to provide a cooled nitrogen gas (N₂) and sulfur gas (S) stream;
a sulfur condenser comprising:
an inlet in fluid communication with the cooled nitrogen gas (N₂) and sulfur gas (S) stream;
a first outlet of the sulfur condenser configured to provide a sulfur gas (S) stream; and
a second outlet of the sulfur condenser configured to provide a separated nitrogen gas (N₂) stream, the separated nitrogen gas (N₂) stream in fluid communication with an inlet of the nitrogen gas (N₂) input stream; and
the heating unit comprising:
the first inlet in fluid communication with the first outlet of the first heat exchanger;
a second inlet in fluid communication with a natural gas stream; and
an outlet in fluid communication with the second inlet of the sulfidation and regeneration system.

16. The reactor system according to claim 15, further comprising:
a second heat exchanger comprising:
a cold inlet configured to receive a hydrogen sulfide (H₂S) stream;
a hot inlet in fluid communication with the second outlet of the sulfidation and regeneration system;
a cold outlet in fluid communication with an inlet of a pressure swing adsorption unit (PSAU); and
a hot outlet in fluid communication with the first inlet of the sulfidation and regeneration system;
an air separation unit comprising:
an inlet configured to receive an air stream; and
an outlet in fluid communication with the nitrogen gas (N₂) input stream; and
a steam turbine comprising:
an inlet in fluid communication with a third inlet of the sulfidation and regeneration system, the third inlet of the sulfidation and regeneration system configured to provide high-pressure steam; and
an outlet configured to provide steam.

17. The reactor system according to claim 15, further comprising:
a cooling unit comprising:
an inlet in fluid communication with the second inlet of the sulfur condenser; and
an outlet in fluid communication with the nitrogen gas (N₂) input stream.

18. The reactor system according to claim 15, further comprising:
a low-pressure stream generator comprising:
an inlet in fluid communication with the second outlet of the first heat exchanger; and
an outlet in fluid communication with the inlet of the sulfur condenser.

19. The reactor system according to claim 15, further comprising:
a blower comprising:
an inlet in fluid communication with the nitrogen gas (N₂) input stream; and
an outlet in fluid communication with the second inlet of the first heat exchanger.

20. A method for operating a reactor system, the method comprising:
providing hydrogen sulfide (H₂S) gas to a first inlet of a sulfidation and regeneration system;
providing nitrogen gas (N₂) to a second inlet of the sulfidation and regeneration system;
generating, in the sulfidation and regeneration system, desulfurized hydrogen-containing gas and sulfur gas (S) by reacting the hydrogen sulfide (H₂S) gas with a plurality of metal sulfide particles;
providing the desulfurized hydrogen-containing gas from a first outlet of the sulfidation and regeneration system;
providing nitrogen gas (N₂) and the sulfur gas (S) from a second outlet of the sulfidation and regeneration system to a first inlet of a first heat exchanger;
providing the nitrogen gas (N₂) and the sulfur gas (S) from a first outlet of the first heat exchanger to an inlet of a sulfur condenser;
obtaining the sulfur gas (S) from a first outlet of the sulfur condenser;
providing the nitrogen gas (N₂) from a second outlet of the sulfur condenser to an inlet of a supplementary nitrogen gas (N₂) stream;
providing the supplementary nitrogen gas (N₂) stream to the second inlet of the first heat exchanger; and
providing the supplementary nitrogen gas (N₂) stream from a second outlet of the first heat exchanger to an inlet of a heating unit; and
providing the supplementary nitrogen gas (N₂) stream from an outlet of the heating unit to the second inlet of the sulfidation and regeneration system.
